(19) United States
(12) Patent Application Publication
(10) Pub. No.: US 2026/0304027 A1
(43) Pub. Date: Oct. 1, 2026

(54) AUDIO APPARATUS

(71) Applicant: Shenzhen Dancing Future Technology Ltd., Shenzhen (CN)

(72) Inventor: Chuanbo WANG, Shenzhen (CN)

(21) Appl. No.: 19/478,253

(22) PCT Filed: Jun. 28, 2024
(86) PCT No.: PCT/CN2024/102730

§ 371 Date: Oct. 23, 2025

(30) Foreign Application Priority Data
Jun. 30, 2023 (CN) 202310792110.5
Jun. 30, 2023 (CN) 202310792176.4

(51) Int. Cl. H04R 1/28; H04R 1/10; H04R 7/02; H04R 7/18; H04R 9/06

(52) U.S. Cl. CPC H04R 1/2811; H04R 1/105; H04R 7/02; H04R 7/18; H04R 9/06

(57) ABSTRACT

The present application discloses an audio apparatus, which includes a sound emitting portion, and the sound emitting portion includes a housing and at least one speaker unit, the speaker unit includes at least one diaphragm, a first cavity is formed between a vibrating outer surface of the diaphragm and an inner wall of the housing, a second cavity is formed between a rear side of the speaker unit and the housing, the first cavity is provided with a first sound outlet hole and a second sound outlet hole, the second cavity is provided with a third sound outlet hole and a fourth sound outlet hole, and connection lines of center positions of projections of the first sound outlet hole, the second sound outlet hole, the third sound outlet hole, and the fourth sound outlet hole on a plane perpendicular to a vibration direction of the diaphragm constitutes a quadrilateral.

The present application claims priority to Chinese Patent Application No. 202310792110.5, filed with the China National Intellectual Property Administration on Jun. 30, 2023 and entitled “AUDIO APPARATUS WITH LEAKAGE PREVENTION”, and Chinese Patent Application No. 202310792176.4, filed with the China National Intellectual Property Administration on Jun. 30, 2023 and entitled “AUDIO APPARATUS”, which are incorporated herein by reference in their entirety.

### TECHNICAL FIELD

The present application relates to a sound emitting apparatus and, in particular, to an audio apparatus.

### BACKGROUND

At present, most of existing open audio apparatuses use a speaker unit diaphragm front and rear or drive two independent diaphragms to form a dipole sound source for silencing, so as to prevent sound leakage. However, compared with a multipole sound source (such as a quadrupole sound source), the dipole sound source cannot achieve the effect of the multipole sound source in terms of leakage prevention, and the leakage prevention effect is not ideal. Sound is easy to leak, which easily disturbs others and has poor privacy, affecting the user experience.

### SUMMARY

An object of the present application is to provide an audio apparatus to solve the problem of a poor leakage prevention effect of a current audio apparatus.

In a first aspect, the present application discloses an audio apparatus, including: a sound emitting portion, where the sound emitting portion includes a housing and at least one speaker unit, the speaker unit includes at least one diaphragm, the speaker unit is disposed inside the housing, a first cavity is formed by enclosing between a front end wall of the diaphragm and an inner peripheral wall of a front end portion of the housing, a second cavity is formed by enclosing between a rear end wall of the diaphragm and an inner peripheral wall of a rear end portion of the housing, the first cavity is provided with a first sound outlet hole and a second sound outlet hole, the second cavity is provided with a third sound outlet hole and a fourth sound outlet hole, the first sound outlet hole, the second sound outlet hole, the third sound outlet hole, and the fourth sound outlet hole are respectively projected on a plane perpendicular to a vibration direction of the diaphragm to form a first projection region, a second projection region, a third projection region, and a fourth projection region, a range of a distance between center points of any two of the first projection region, the second projection region, the third projection region, and the fourth projection region is 0 mm to 25 mm, and the first projection region and the second projection region are respectively located on two sides of a straight line where a connection line between the center point of the third projection region and the center point of the fourth projection region is located.

In a second aspect, the present application discloses an audio apparatus, including: a sound emitting portion, where the sound emitting portion includes a housing and at least one speaker unit, the speaker unit includes at least one diaphragm, the speaker unit is disposed inside the housing, a first cavity is formed by enclosing between a front end wall of the diaphragm and an inner peripheral wall of a front end portion of the housing, a second cavity is formed by enclosing between a rear end wall of the diaphragm and an inner peripheral wall of a rear end portion of the housing, the first cavity is provided with a first sound outlet hole and a second sound outlet hole, the second cavity is provided with a third sound outlet hole and a fourth sound outlet hole, the first sound outlet hole, the second sound outlet hole, the third sound outlet hole, and the fourth sound outlet hole are respectively projected on a plane perpendicular to a vibration direction of the diaphragm to form a first projection region, a second projection region, a third projection region, and a fourth projection region, a range of a distance between center points of any two of the first projection region, the second projection region, the third projection region, and the fourth projection region is 0 mm to 25 mm, and the first projection region and the second projection region are located on a straight line where a connection line between the center point of the third projection region and the center point of the fourth projection region is located, or on a same side of the straight line where the connection line between the center point of the third projection region and the center point of the fourth projection region is located.

With reference to the above technical solution, in the present application, the first cavity and the second cavity are provided at the front end and the rear end of the speaker unit, and the first cavity is provided with the first sound outlet hole and the second sound outlet hole, and the second cavity is provided with the third sound outlet hole and the fourth sound outlet hole. The sound emitted from the first sound outlet hole and the second sound outlet hole has the same amplitude and opposite phase as the sound emitted from the third sound outlet hole and the fourth sound outlet hole, thereby forming a multipole sound source. The multipole sound source has a better attenuation for the middle and low frequency bands, especially the middle frequency band that is sensitive to human ears. When the multipole sound source is used in a non-invasive audio apparatus, sound leakage may be effectively prevented and user privacy may be improved.

### BRIEF DESCRIPTION OF DRAWINGS

FIG. 1 is a schematic diagram of a sound generation principle of a dipole sound source;

FIG. 2 is a schematic diagram of a sound generation principle of a quadrupole sound source;

FIG. 3 is a diagram of structural names of a human ear auricle model;

FIG. 4 is a front view of an audio apparatus according to an embodiment of the present application;

FIG. 5 is a right view of the audio apparatus according to an embodiment of the present application;

FIG. 6 is a rear view of the audio apparatus according to an embodiment of the present application;

FIG. 7 is a left view of the audio apparatus according to an embodiment of the present application;

FIG. 8 is a diagram of a wearing state of the audio apparatus according to an embodiment of the present application;

FIG. 9 is a schematic projection view of FIG. 8 in a YZ plane;

FIG. 10(a) to FIG. 10(j) are structural diagrams of arrangements of a first sound hole, a second sound hole, a third sound hole, and a fourth sound hole of an audio apparatus according to the present application;

FIG. 11(a) to FIG. 11(h) are layout diagrams of FIG. 10(a) to FIG. 10(j) rotated by a certain angle;

FIG. 12 is a structural diagram of an audio apparatus with a convex structure according to an embodiment of the present application;

FIG. 13 is a structural diagram of a speaker unit of an audio apparatus being a dual-diaphragm single voice coil according to an embodiment of the present application;

FIG. 14 is a structural diagram of a speaker unit of an audio apparatus being a dual-diaphragm dual voice coil according to another embodiment of the present application;

FIG. 15 is a structural diagram of a speaker unit of an audio apparatus being a passive diaphragm and a single voice coil according to another embodiment of the present application;

FIG. 16 is a structural diagram of a speaker unit of an audio apparatus being a single diaphragm and a single voice coil according to another embodiment of the present application;

FIG. 17 is a structural diagram of a speaker unit of an audio apparatus being two speakers according to another embodiment of the present application;

FIG. 18 is a structural diagram of a speaker unit of an audio apparatus being four speakers according to another embodiment of the present application;

FIG. 19 is a structural diagram of a speaker unit of an audio apparatus being two dual-diaphragm speakers according to another embodiment of the present application;

FIG. 20 is a comparison diagram of frequency response curves of a quadrupole sound source and a dipole sound source of an audio apparatus according to an embodiment of the present application;

FIG. 21 is a comparison diagram of sound leakage curves of a quadrupole sound source and a dipole sound source of an audio apparatus according to an embodiment of the present application;

FIG. 22 is a perspective view of an audio apparatus according to the present application;

FIG. 23 is a front view of an audio apparatus according to the present application;

FIG. 24 is a rear view of an audio apparatus according to the present application;

FIG. 25 is a schematic diagram of an audio apparatus with a convex structure according to the present application;

FIG. 26 is a diagram of a wearing state of an audio apparatus according to the present application;

FIG. 27 is a schematic projection view of FIG. 26 in a YZ plane;

FIG. 28 is a schematic projection view of FIG. 26 in an XY plane;

FIG. 29 is a diagram of a wearing state of another structure of an audio apparatus according to the present application;

FIG. 30 is a schematic projection view of FIG. 29 in a YZ plane;

FIG. 31 is a schematic projection view of the audio apparatus of FIG. 29 in an XY plane;

FIG. 32 is a cross-sectional view of a dual-diaphragm single voice coil type of an audio apparatus according to the present application;

FIG. 33 is a cross-sectional view of a dual-diaphragm dual voice coil type of an audio apparatus according to the present application;

FIG. 34 is a cross-sectional view of a single-diaphragm single voice coil type of an audio apparatus according to the present application; and

FIG. 35 is a cross-sectional view of a dual-diaphragm single voice coil type of an audio apparatus according to the present application.

### DETAILED DESCRIPTION

In the embodiments of the present application, the term “and/or” describes an association relationship between associated objects, and represents that three relationships may exist. For example, A and/or B may represent the following three cases: only A exists, both A and B exist, and only B exists. The character “/” generally indicates an “or” relationship between the associated objects.

In the embodiments of the present application, the term “multiple” refers to two or more, and other quantifiers are similar thereto.

The technical solutions in the embodiments of the present application will be described clearly and completely with reference to the drawings in the embodiments of the present application. It is clear that the described embodiments are only some embodiments of the present application, rather than all the embodiments. All other embodiments obtained by a person of ordinary skill in the art based on the embodiments of the present application without creative efforts shall fall within the protection scope of the present application.

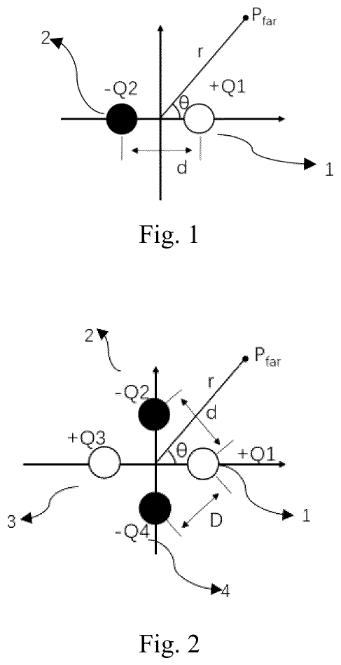

A principle of forming a multipole by dipoles is as follows: A multipole sound source may be regarded as a combination of dipole sound sources with opposite polarities. A dipole sound source and a transverse quadrupole sound source are formed as shown in FIG. 1 and FIG. 2. The dipole sound source is composed of a point sound source 1 and a point sound source 2 as shown in the figure. The point sound source 1 and the point sound source 2 have the same amplitude and opposite phases, and a distance therebetween is d. An expression of a sound pressure P_{far} at a distance r from the dipole sound source in the sound field is as shown in Expression 1.

$$\vert p ( r , θ , t ) \vert = \frac{Q ρ c k}{4 π r} kd cos θ \qquad ( 1 )$$

The quadrupole sound source is composed of two dipole sound sources with opposite phases. As shown in FIG. 2, the point sound source 1 and the point sound source 2 have the same amplitude and opposite phases, and a distance therebetween is d, to form a first dipole sound source; a point sound source 3 and a point sound source 4 have the same amplitude and opposite phases, and a distance therebetween is d, to form a second dipole sound source; and the first dipole sound source and the second dipole sound source have opposite phases, and a distance therebetween is D. With the spatial layout shown in FIG. 2, a transverse quadrupole sound source is formed, and a sound pressure P_{far} at a distance r from the transverse quadrupole sound source is as shown in Expression 2.

$$\vert p ( r , θ , t ) \vert = \frac{Q ρ ck}{4 π r} 4 {k}^{2} dD cos θ sin θ \qquad ( 2 )$$

In the above Expressions 1 and 2:
C—sound velocity
ρ—medium density
r—distance from a certain position in the sound field to the sound source
d—dipole sound source spacing
D—spacing between two dipole sound sources
Q—volume velocity of the sound source surface
k—wave node, k=2*π/λ
θ—sound source radiation angle.

Through a comparison between Expression 1 and Expression 2, there is a ratio between the quadrupole sound source and the dipole sound source as shown in Expression 3:

4kD sin θ Expression (3)

For the middle and low frequency sound waves, the wavelength 2 is very large. When the distance between two pairs of dipoles is small, the following is satisfied:

4kD sin θ<1

When the amplitudes of the point sound sources are exactly the same, the sound pressure radiated by the quadrupole sound source is smaller than that radiated by the dipole sound source. Therefore, it may be seen that the sound leaking outward from the quadrupole sound source and the dipole sound source is smaller.

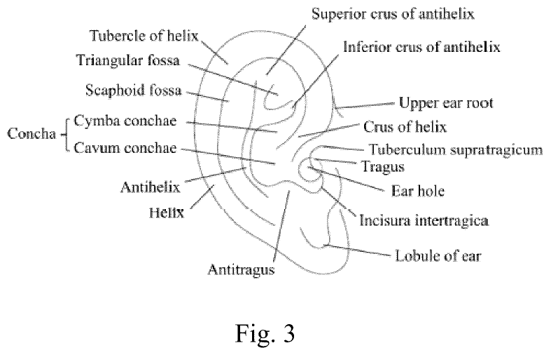

At the same time, it is also necessary to understand the structure of the auricle, because the audio apparatus is worn on the ear, and it is necessary to know the names of parts of the ear. The specific ear structure is shown in FIG. 3.

The auricle models are all simulators including a head and an auricle thereof, which are designed and manufactured in accordance with the IEC: 60318-7 standard or the ANSI: S3.36, S3.25 standard, such as the 4128C artificial head and torso simulator from B&K or the 45BC KEMAR artificial head and torso from GRAS.

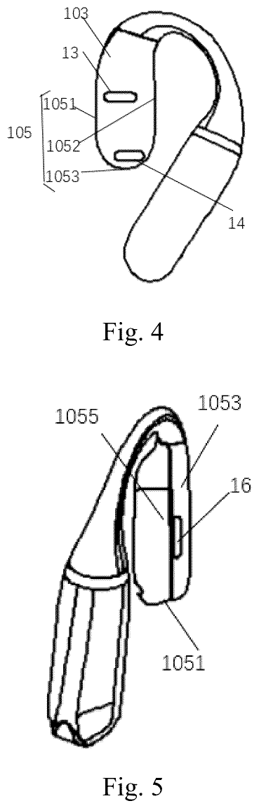

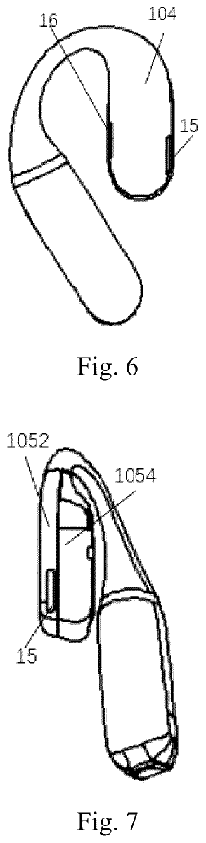

As shown in FIG. 4 to FIG. 9, in an embodiment of the present application, the audio apparatus includes a housing 10 and at least one speaker unit 20. The speaker unit 20 includes at least one diaphragm. A first cavity 11 is formed between a vibrating outer surface of the diaphragm and an inner wall of the housing 10. A second cavity 12 is formed between a rear side of the speaker unit 20 and the housing 10. The first cavity 11 is provided with a first sound outlet hole 13 and a second sound outlet hole 14. The second cavity 12 is provided with a third sound outlet hole 15 and a fourth sound outlet hole 16. The amplitude of a sound wave radiated by the first cavity 11 through the first sound outlet hole 13 and the second sound outlet hole 14 is the same as the amplitude of a sound wave radiated by the second cavity 12 through the third sound outlet hole 15 and the fourth sound outlet hole 16, and the phases of the two sound waves are opposite. The first sound outlet hole 13, the second sound outlet hole 14, the third sound outlet hole 15, and the fourth sound outlet hole 16 are projected on a plane perpendicular to a vibration direction of the diaphragm to form a first projection region 131, a second projection region 141, a third projection region 151, and a fourth projection region 161. An outer periphery of a connection line of center positions of the four projection regions constitutes a quadrilateral. The first projection region 131 and the second projection region 141 are respectively located on two sides of a connection line between a center point of the third projection region 151 and a center point of the fourth projection region 161, as shown in FIG. 9.

The closer the quadrilateral shape is to the rectangular shape of an ideal transverse quadrupole, the better the effect of preventing sound leakage.

In some implementations, the quadrilateral is a parallelogram.

In some implementations, an interior angle of the quadrilateral is greater than 28°; or an included angle between diagonals of the quadrilateral is less than 90°.

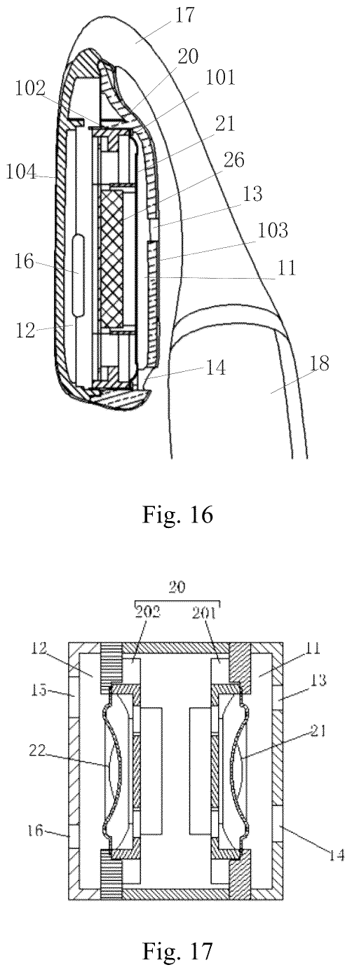

In an embodiment, the speaker unit 20 is provided with one diaphragm, the first cavity 11 is provided on one side of the diaphragm, and the second cavity 12 is provided on a front side away from the diaphragm. Through the action of the internal coupling structure of the speaker unit 20, the sound signals emitted from the sound outlet holes by the first cavity 11 and the second cavity 12 have the same amplitude and opposite phases. In this case, one speaker is provided in the housing 10, and the speaker has one diaphragm, as shown in FIG. 16.

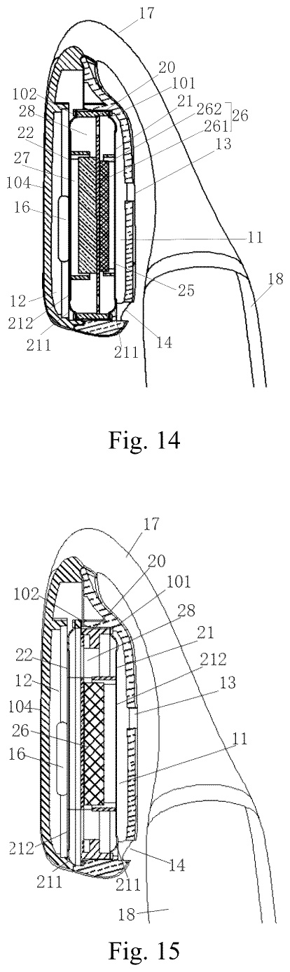

In an embodiment, the speaker unit 20 is provided with two diaphragms, which are a first diaphragm 21 and a second diaphragm 22, respectively. The first diaphragm 21 corresponds to the first cavity 11, and the second diaphragm 22 corresponds to the second cavity 12. The sound signals radiated by the vibration of the first diaphragm 21 and the second diaphragm 22 have the same amplitude and opposite phases. The design of two diaphragms may be implemented in the following manners.
1. It is provided by a speaker unit 20 with dual diaphragms and dual voice coils, as shown in FIG. 14. The first diaphragm 21 is fixedly connected to one of the voice coils, and the second diaphragm 22 is fixedly connected to the other voice coil. The two voice coils drive respective diaphragms to emit sound signals with the same amplitude and opposite phases. In some implementations, the dual-diaphragm dual voice coil speaker unit 20 is in a series relationship in electrical connection.
2. It is provided by a speaker unit 20 with dual diaphragms and a single voice coil, as shown in FIG. 13. The first diaphragm 21 is fixedly connected to the voice coil, and the second diaphragm 22 is a passive diaphragm mounted and fixed on the speaker unit 20. The first diaphragm 21, the second diaphragm 22, and a speaker unit housing form a sealed cavity. When the first diaphragm 21 vibrates under a driving force, the first diaphragm 21 pushes the air in the sealed cavity to further push the second diaphragm 22 to vibrate in the same direction, so that the first diaphragm 21 and the second diaphragm 22 emit sound signals with the same amplitude and opposite phases. In this implementation, the voice coil may be configured to be connected to both the first diaphragm 21 and the second diaphragm 22, and the first diaphragm 21 and the second diaphragm 22 vibrate in the same direction under the driving of the voice coil.
3. It is provided by two speaker units 20, as shown in FIG. 17. One speaker unit 20 is provided with the first diaphragm 21, and the other speaker unit 20 is provided with the second diaphragm 22, that is, the first diaphragm 21 and the second diaphragm 22 are both diaphragms on the two speaker units 20. By controlling the current of the control circuit, the first diaphragm 21 and the second diaphragm 22 of the two speaker units 20 emit sound signals with the same amplitude and opposite phases.
4. It is provided by a speaker unit 20 and a passive diaphragm mounted on the housing of the audio apparatus, but the passive diaphragm is provided separately from the speaker unit, as shown in FIG. 15. The speaker unit 20 is provided with a diaphragm, that is, the first diaphragm 21, forming dual diaphragms with the passive diaphragm which is the second diaphragm 22 provided on the audio apparatus. A sealed space 28 is formed between the first diaphragm 21 and the second diaphragm 22 and the housing of the audio apparatus. When the first diaphragm 21 vibrates under the driving force, the first diaphragm 21 pushes the air in the sealed cavity to further push the second diaphragm 22 to vibrate in the same direction.

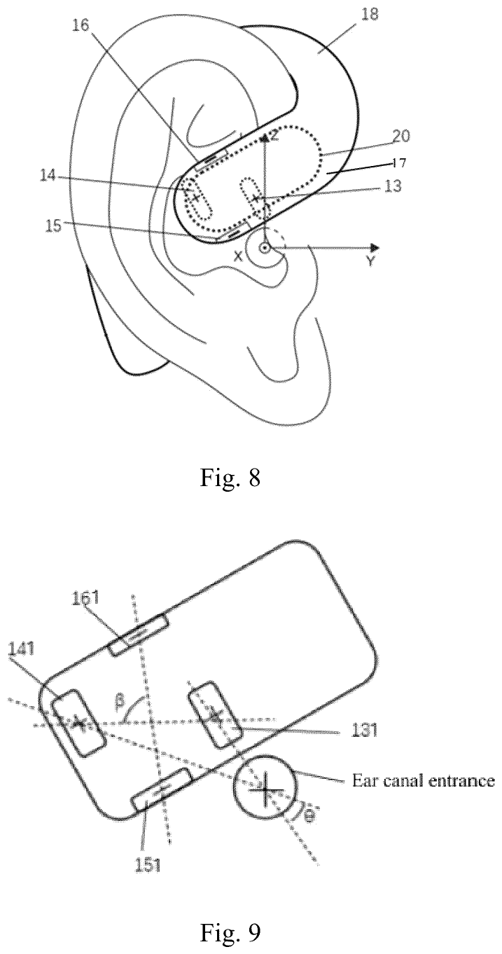

Referring to FIG. 3 and FIG. 8, in the wearing state, the first sound outlet hole 13 and the second sound outlet hole 14 are located between the antitragus, the antihelix, the tragus, and the inferior crus of antihelix. The third sound outlet hole 15 and the fourth sound outlet hole 16 are located between the antitragus, the antihelix, the tragus, and the inferior crus of antihelix. In some implementations, the third sound outlet hole 15 may also be located at a position 5 mm away from the ear root; or at a position outside the auricle and 10 mm away from the tragus. In the wearing state, the relationship between the first sound outlet hole 13, the second sound outlet hole 14, the third sound outlet hole 15, and the fourth sound outlet hole 16 and the auricle is the best for the apparatus.

As shown in FIG. 4 to FIG. 8, the first sound outlet hole 13 and the second sound outlet hole 14 are located on the first surface 103 and emit positive-phase signals. The center of the first sound outlet hole 13 is closer to the center of the ear canal opening than the center of the second sound outlet hole 14, and the distance from the center of the first sound outlet hole 13 and the center of the second sound outlet hole 14 to the center of the ear canal opening is less than or equal to 15 mm. The second sound outlet hole 14 is close to the cymba conchae, and the distance therebetween is less than or equal to 10 mm.

The third sound outlet hole 15 and the fourth sound outlet hole 16 are farther from the ear canal opening than the first sound outlet hole 13, and the distance from the third sound outlet hole 15 and the fourth sound outlet hole 16 to the ear canal opening is 20 mm to 35 mm.

In some implementations, the fourth sound outlet hole 16 is located on the side surface 105, and the opening direction is toward the auricle. The fourth sound outlet hole 16 is opened toward a region where the inferior crus of antihelix and the antihelix are located.

In some implementations, the closest distance between the center of the fourth sound outlet hole 16 and the antihelix is 2 mm to 10 mm; and the closest distance between the fourth sound outlet hole 16 and the inferior crus of antihelix is 3 mm to 12 mm. In a state that the user wears the audio apparatus, the range of the included angle between the fourth sound outlet hole 16 and a vertical axis is 10° to 35°.

In some implementations, the third sound outlet hole 15 is located on the side surface 105, and the opening direction of the third sound outlet hole 15 is toward the antitragus region. The closest distance between the center of the third sound outlet hole 15 and the antitragus is 2 mm to 12 mm. In the state that the user wears the audio apparatus, the range of the included angle between the third sound outlet hole 15 and the vertical axis is 10° to 35°.

In some implementations, the opening area of each of the first sound outlet hole 13, the second sound outlet hole 14, the third sound outlet hole 15, and the fourth sound outlet hole 16 is greater than or equal to 4 mm².

As shown in FIG. 13 to FIG. 15, a first assembly surface 101 and a second assembly surface 102 are provided inside the housing 10. The speaker unit 20 is fixed inside the housing 10 and located between the first assembly surface 101 and the second assembly surface 102, so that the first diaphragm 21 is mounted on the first assembly surface 101, and the second diaphragm 22 is mounted on the second assembly surface 102. Other components of the speaker unit 20 are arranged in a cavity between the first assembly surface 101 and the second assembly surface 102.

In other embodiments, the surface connecting the first assembly surface 101 and the second assembly surface 102 is referred to as an inner side surface. The first diaphragm 21 or the second diaphragm 22 may be provided on the inner side surface according to actual needs.

As shown in FIG. 4 to FIG. 7, the outer surface of the housing 10 includes a first surface 103, a second surface 104, and a side surface 105. The first surface 103 is disposed close to the ear hole, and the second surface 104 is disposed toward the outer side. An outer surface of the first cavity 11 is the first surface 103, and an outer surface of the second cavity 12 is the second surface 104. The side surface 105 is a side surface connecting the first surface 103 and the second surface 104. For a more detailed distinction, the side surface 105 includes a first side surface 1051, a second side surface 1052, and a third side surface 1053. The third side surface 1053 is a side surface connecting the first surface 103 and the second surface 104 at the bottom of the housing 10. The first side surface 1051 and the second side surface 1052 are respectively disposed on two sides of the third side surface 1053, and the first side surface 1051 and the second side surface 1052 are connected to the side edges of the first surface 103 and the second surface 104.

The first sound outlet hole 13 and the second sound outlet hole 14 may be located on the first surface 103 of the product at the same time, or on the side surface 105 at the same time, or respectively on the first surface 103 and the side surface 105, or on the second surface 104 at the same time, or respectively on the second surface 104 and the side surface 105. The positions of the first sound outlet hole 13 and the second sound outlet hole 14 are set according to the needs of an actual product.

In other embodiments, the first sound outlet hole 13 and the second sound outlet hole 14 are not directly communicated with the first cavity 11, and the first sound outlet hole 13 and the second sound outlet hole 14 are communicated with the first cavity 11 through a first sound guide tube according to design requirements. The first sound guide tube may be formed by a separate tube body or by a gap between various components.

The third sound outlet hole 15 and the fourth sound outlet hole 16 may be located on the second surface 104 of the product at the same time, or on the side surface 105 at the same time, or respectively on the second surface 104 and the side surface 105, or on the first surface 103 at the same time, or respectively on the first surface 103 or the side surface 105. The positions of the third sound outlet hole 15 and the fourth sound outlet hole 16 are set according to the needs of the actual product.

In an implementation process, the first sound outlet hole 13 and the second sound outlet hole 14 radiate positive-phase sound waves with the same phase, and the third sound outlet hole 15 and the fourth sound outlet hole 16 radiate anti-phase sound waves with the same phase.

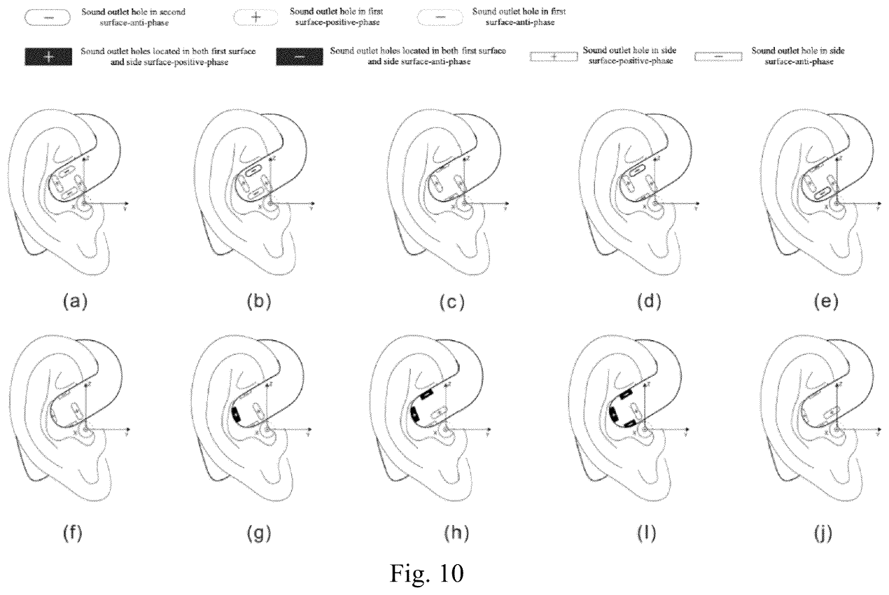

As shown in FIG. 10a, the first sound outlet hole 13 and the second sound outlet hole 14 are located on the first surface 103 at the same time, and the third sound outlet hole 15 and the fourth sound outlet hole 16 are located on the second surface 104 at the same time.

As shown in FIG. 10b, the first sound outlet hole 13 and the second sound outlet hole 14 are located on the first surface 103 at the same time, and the third sound outlet hole 15 and the fourth sound outlet hole 16 are respectively located on the first surface 103 and the second surface 104.

As shown in FIG. 10c, the first sound outlet hole 13 and the second sound outlet hole 14 are located on the first surface 103 at the same time, and the third sound outlet hole 15 and the fourth sound outlet hole 16 are located on the side surface 105 at the same time.

As shown in FIG. 10d, the first sound outlet hole 13 and the second sound outlet hole 14 are located on the first surface 103 at the same time, and the third sound outlet hole 15 and the fourth sound outlet hole 16 are respectively located on the side surface 105 and the second surface 104.

As shown in FIG. 10e, the first sound outlet hole 13 and the second sound outlet hole 14 are located on the first surface 103 at the same time, and the third sound outlet hole 15 and the fourth sound outlet hole 16 are respectively located on the second surface 104 and the side surface 105.

As shown in FIG. 10f, the first sound outlet hole 13 and the second sound outlet hole 14 are respectively located on the first surface 103 and the side surface 105, and the third sound outlet hole 15 and the fourth sound outlet hole 16 are located on the side surface 105 at the same time.

As shown in FIG. 10g, the first sound outlet hole 13 is located on the first surface 103, the second sound outlet hole 14 is located on both the first surface 103 and the side surface 105, and the third sound outlet hole 15 and the fourth sound outlet hole 16 are located on the side surface 105 at the same time.

As shown in FIG. 10h, the first sound outlet hole 13 is located on the first surface 103, the second sound outlet hole 14 is located on both the first surface 103 and the side surface 105, the third sound outlet hole 15 is located on the side surface 105, and the fourth sound outlet hole 16 is located on both the second surface 104 and the side surface 105.

As shown in FIG. 10i, the first sound outlet hole 13 is located on the first surface 103, the second sound outlet hole 14 is located on both the first surface 103 and the side surface 105, and the third sound outlet hole 15 and the fourth sound outlet hole 16 are both located on the second surface 104 and the side surface 105 at the same time.

As shown in FIG. 10j, it is a solution of adjusting the angle of the first sound outlet hole 13 in FIG. 10f.

According to the principle of the quadrupole sound source, the closer the distance between sound sources in opposite phases, the smaller the sound received by the far sound field. At the same time, considering the appearance of the product, a solution in which the first sound outlet hole 13 is close to the ear canal opening and other sound outlet holes are located on the side of the product is preferentially considered, and preferred solutions are FIG. 10c, FIG. 10f, FIG. 10g, and FIG. 10j.

In space, two pairs of dipole sound sources with opposite phases and the same amplitude are relatively close to each other, forming a transverse quadrupole sound source. In FIG. 10a to FIG. 10j, the sound wave radiated from the sound outlet hole marked with “−” is anti-phase, and the sound wave radiated from the sound outlet hole marked with “+” is positive-phase.

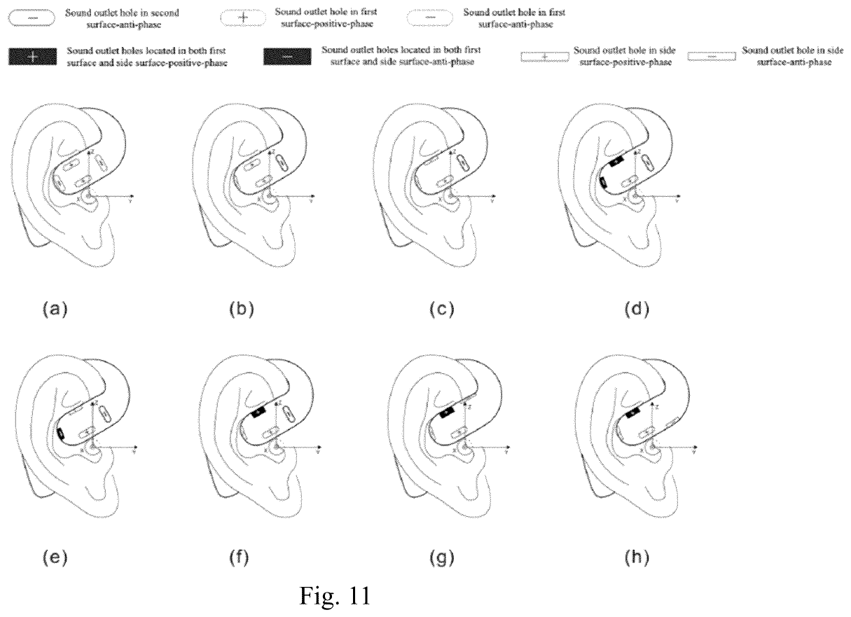

In implementation process, by adjusting the array angle and position of the first sound outlet hole 13, the second sound outlet hole 14, the third sound outlet hole 15, and the fourth sound outlet hole 16, for example, rotating clockwise by 90° with the first sound outlet hole as the center, the solutions shown in FIG. 11a to FIG. 11j are possible.

In other embodiments, the third sound outlet hole 15 and the fourth sound outlet hole 16 are not directly communicated with the second cavity 12, and the third sound outlet hole 15 and the fourth sound outlet hole 16 are communicated with the second cavity 12 through a second sound guide tube according to design requirements.

In order to achieve the purpose of protecting sound privacy by reducing the sound leakage in the far sound field of the acoustic quadrupole, the first sound outlet hole 13 and the second sound outlet hole 14 are projected on a plane perpendicular to the vibration direction of the diaphragm of the speaker unit 20 to form a first projection region 131 and a second projection region 141. The center distance between the first projection region 131 and the second projection region 141 is less than or equal to 25 mm, and the first sound outlet hole 13 and the second sound outlet hole 14 emit sounds with the same amplitude and the same phase.

In some implementations, the third sound outlet hole 15 is projected on the plane perpendicular to the vibration direction of the diaphragm of the speaker unit 20 to form a third projection region 151, and the center distance between the third projection region 151 and the first projection region 131 is less than or equal to 15 mm.

In some implementations, the third sound outlet hole 15 is projected on a plane parallel to the vibration direction of the diaphragm of the speaker unit 20, and the first sound outlet hole 13 is projected on the plane parallel to the vibration direction of the diaphragm of the speaker unit 20. The center distance between the above two projections is less than 13 mm.

In some implementations, the center distance between the first sound outlet hole 13 and the third sound outlet hole 15 is less than or equal to 16 mm.

The third sound outlet hole 15 and the first sound outlet hole 13 emit a sound with the same amplitude and opposite phase. The first sound outlet hole 13 is closer to the ear hole than the third sound outlet hole 15, and the distance from the first sound outlet hole 13 to the ear hole is less than or equal to 15 mm.

The fourth sound outlet hole 16 is projected on the plane perpendicular to the vibration direction of the diaphragm of the speaker unit 20 to form a fourth projection region 161. The center distance between the third projection region 151 and the fourth projection region 161 is less than or equal to 25 mm, and the third sound outlet hole 15 and the fourth sound outlet hole 16 emit sounds with the same amplitude and the same phase.

In some implementations, the center distance between the fourth projection region 161 and the second projection region 141 is less than or equal to 15 mm.

In some implementations, the fourth sound outlet hole 16 is projected on a plane parallel to the vibration direction of the diaphragm of the speaker unit 20, and the second sound outlet hole 14 is projected on the plane parallel to the vibration direction of the diaphragm of the speaker unit 20. The center distance between the above two projections is less than 13 mm.

In some implementations, the center distance between the first sound outlet hole 13 and the fourth sound outlet hole 16 is less than or equal to 20 mm.

In some implementations, the fourth sound outlet hole 16 and the second sound outlet hole 14 emit a sound with the same amplitude and opposite phase.

In some implementations, a midpoint of a connection line between the center point of the first projection region 131 and the center point of the third projection region 151 is set as a first midpoint, and a midpoint of a connection line between the center point of the second projection region 141 and the center point of the third projection region 151 is set as a second midpoint. The range of the distance between the first midpoint and the second midpoint is 7 mm to 25 mm.

The difference between the distances between the center points of any two of the first projection region 131, the second projection region 141, the third projection region 151, and the fourth projection region 161 is less than 15 mm.

In a state that the audio apparatus is worn, the center of the first sound outlet hole 13 is farther from the center of the ear hole than the center of the second sound outlet hole 14, and the distance from the center of the first sound outlet hole 13 and the center of the second sound outlet hole 14 to the center of the ear hole is less than 15 mm. The second sound outlet hole 14 is closer to the cymba conchae, and the distance between the center of the second sound outlet hole 14 and the cymba conchae is less than or equal to 10 mm. The distance between the second sound outlet hole 14 and the cymba conchae is less than or equal to 10 mm, and the third sound outlet hole 15 is closer to the ear opening than the fourth sound outlet hole 16.

The opening direction of the fourth sound outlet hole 16 is toward the auricle. In some implementations, the fourth sound outlet hole 16 is opened toward the inferior crus of antihelix, the antihelix, and the antitragus. The closest distance between the center of the fourth sound outlet hole 16 and the antihelix is between 2 mm and 10 mm, the closest distance between the fourth sound outlet hole 16 and the inferior crus of antihelix is between 3 mm and 12 mm, the closest distance between the fourth sound outlet hole 16 and the antitragus is between 2 mm and 7 mm, and the included angle between the fourth sound outlet hole 16 and the vertical axis of the user is 10° to 35°.

As shown in FIG. 8, the part of the audio apparatus exposed on the front side of the auricle is defined as a sound emitting portion 17, and the part between the rear side of the auricle, that is, between the auricle and the head side, is defined as a hook-shaped band 18, where the hook-shaped band 18 is connected to the sound emitting portion 17. In order to more clearly describe the relationship between the audio apparatus and the human ear, an XYZ coordinate system is defined with the ear canal entrance as the origin. As shown in FIG. 8, the direction outward from the ear canal entrance is defined as the positive X half-axis and also defined as the thickness direction; the direction upward from the ear canal entrance and toward the top of the head is defined as the positive Z half-axis and also defined as the height direction; and the direction from the ear canal entrance toward the face is defined as the positive Y half-axis.

The hook-shaped band 18 of the audio apparatus is connected to the sound emitting portion 17 and worn on the auricle, and the sound emitting portion 17 is located on the front side of the auricle. The sound emitting portion 17 has a long axis and a short axis that are orthogonal to each other in a direction perpendicular to the vibration direction of the diaphragm of the speaker unit 20. The long axis of the sound emitting portion 17 is projected on the YZ plane to form a certain included angle with the Y axis. In some implementations, the included angle is 15° to 50°. Further, in some implementations, the included angle is between 35° and 50°.

As shown in FIG. 4 to FIG. 8, the audio apparatus has a second side surface 1052 intersecting with the first surface 103, that is, a common side edge of the second side surface 1052 and the first surface 103, to form a first edge 1054. The first edge 1054 is higher than the tragus tubercle in the Z-axis direction. This design avoids excessive contact between the audio apparatus and the supratragic tubercle, thereby avoiding discomfort caused when the audio apparatus is worn. The first side surface 1051 is disposed opposite to the second side surface 1052 to form a tetrahedron-like structure in this embodiment, but it is not limited to this structure and may also be circular, elliptical, etc. A second edge 1055 is formed at the connection between the third side surface 1053 and the first surface 103. With reference to FIG. 8, a partial position of the second edge 1055 contacts the intersection region of the upper ear root and the helix.

The audio apparatus is projected in the thickness direction (the X-axis direction in FIG. 8) to cover the cymba conchae, the crus of helix, and part of the cavum conchae and part of the ear canal opening. The third side surface 1053 of the sound emitting portion 17 is set as arc-shaped in the height direction (the Z-axis direction in FIG. 8), and the arc radius is not less than 6.3 mm. The third side surface 1053 is far from the ear canal opening and close to the antihelix, and the distance from the third side surface 1053 to the antihelix is not less than 2 mm.

As shown in FIG. 8 to FIG. 9, it is a structural schematic diagram of a first sound outlet hole 13, a second sound outlet hole 14, a third sound outlet hole 15, and a fourth sound outlet hole 16 of an audio apparatus on a human ear auricle. The first sound outlet hole 13 and the second sound outlet hole 14 are disposed on a first surface 103 of a sound emitting portion 17, as shown by dotted racetrack-shaped small holes in FIG. 8. The third sound outlet hole 15 and the fourth sound outlet hole 16 are disposed on a second surface 104 of the sound emitting portion 17, as shown by solid square holes in FIG. 8.

The long axes of the first sound outlet hole 13 and the second sound outlet hole 14 form an included angle of 0° to 150° with the plane where the short axis of the audio apparatus is located, and the included angle is 0° in FIG. 8 of this embodiment.

In some implementations, the ratio of the length of each of the first sound outlet hole 13 and the second sound outlet hole 14 in the long axis direction to the length in the short axis direction is greater than 2.5.

The third sound outlet hole 15 and the fourth sound outlet hole 16 are farther from the ear canal opening than the first sound outlet hole 13, and the distance from the third sound outlet hole 15 and the fourth sound outlet hole 16 to the ear canal opening is 20 mm to 35 mm.

In some implementations, the fourth sound outlet hole 16 is located on a side surface 105, and the opening direction is toward the auricle. The fourth sound outlet hole 16 is opened toward the region where the inferior crus of antihelix and the antihelix are located.

In some implementations, the closest distance between the center of the fourth sound outlet hole 16 and the antihelix is 2 mm to 10 mm; and the closest distance between the fourth sound outlet hole 16 and the inferior crus of antihelix is 3 mm to 12 mm. In a state that the user wears the audio apparatus, the range of the included angle between the fourth sound outlet hole 16 and a vertical axis is 10° to 35°.

In some implementations, the third sound outlet hole 15 is located on the side surface 105, and the opening direction of the third sound outlet hole 15 is toward an antitragus region. The closest distance between the center of the third sound outlet hole 15 and the antitragus is 2 mm to 12 mm. In the state that the user wears the audio apparatus, the range of the included angle between the third sound outlet hole 15 and the vertical axis is 10° to 35°.

The ratio of the length of each of the first sound outlet hole 13 and the second sound outlet hole 14 in the long axis direction to the length of the audio apparatus in the long axis direction is not less than 0.618.

The third sound outlet hole 15 and the fourth sound outlet hole 16 are farther from the ear canal opening than the first sound outlet hole 13, and the distance therebetween is 20 mm to 35 mm. In some implementations, the fourth sound outlet hole 16 is located on the side surface 105, and the opening direction is toward the auricle. Further, in some implementations, the fourth sound outlet hole 16 is opened toward the region where the inferior crus of antihelix and the antihelix are located. The closest distance between the center of the fourth sound outlet hole 16 and the antihelix is 2 mm to 10 mm. The closest distance between the fourth sound outlet hole 16 and the inferior crus of antihelix is 3 mm to 12 mm, and the range of the included angle between the fourth sound outlet hole 16 and the vertical axis of the user is 10° to 35°.

In some implementations, the third sound outlet hole 15 is located on the side surface 105, and the opening direction of the third sound outlet hole 15 is toward the antitragus region. The closest distance between the center of the third sound outlet hole 15 and the antitragus is 2 mm to 12 mm, and the range of the included angle between the third sound outlet hole 15 and the vertical axis of the user is 10° to 35°.

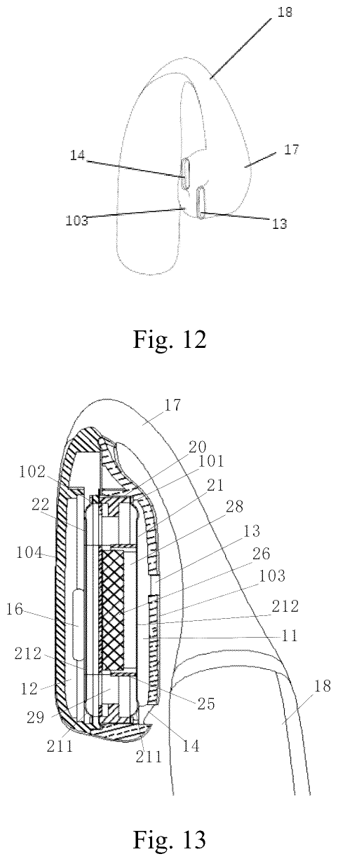

As shown in FIG. 12, a convex structure 106 is provided on the first surface 103 of the audio apparatus toward the cavum conchae. The first sound outlet hole 13 and the second sound outlet hole 14 are disposed on the convex structure 106. The convex structure 106 is higher than the first surface 103. In some implementations, the height of the convex structure 106 higher than the first surface 103 is 0.5 mm to 3 mm. The convex structure 106 where the first sound outlet hole 13 is located is higher than the convex structure 106 where the second sound outlet hole 14 is located relative to the first surface 103, by at least 0.5 mm, that is, the height of the convex structure 106 is matched with the structure of the ear according to the audio apparatus, so that more sound may be transmitted into the ear hole.

As shown in FIG. 8 to FIG. 9, after the audio apparatus is normally worn, the center connection line of the first sound outlet hole 13 and the second sound outlet hole 14 of the audio apparatus forms an included angle of 25° to 70° with the YZ plane of the above coordinate system; forms an included angle of less than or equal to 150° with the XY plane; and forms an included angle of less than or equal to 150° with the XZ plane.

In other embodiments, after the audio apparatus is normally worn, the included angle between the plane perpendicular to the average normal of the first sound outlet hole 13 and the YZ plane is less than or equal to 40°.

In other embodiments, the included angle between the center connection line of the first sound outlet hole 13 and the second sound outlet hole 14 and the plane formed by the ear root, the antihelix, and the tragus notch of the ear is less than or equal to 35°.

In other embodiments, the included angle between the plane perpendicular to the average normal of the first sound outlet hole 13 and the plane formed by the upper ear root, the antihelix, and the tragus notch of the ear is less than or equal to 35°.

The center connection line of the third sound outlet hole 15 and the fourth sound outlet hole 16 forms an included angle of less than or equal to 70° with the ZY plane; forms an included angle of less than or equal to 150° with the XY plane; and forms an included angle of less than or equal to 130° with the XZ plane.

The included angle between the plane perpendicular to the average normal of the third sound outlet hole 15 and the YZ plane is less than or equal to 82°.

The included angle between the center connection line of the third sound outlet hole 15 and the fourth sound outlet hole 16 and the plane formed by the upper ear root, the antihelix, and the tragus notch of the ear is less than or equal to 35°.

The included angle between the plane perpendicular to the average normal of the first sound outlet hole 13 and the plane formed by the upper ear root, the antihelix, and the tragus notch of the ear is less than or equal to 65°.

The fourth sound outlet hole 16 is opened toward the antihelix, and after the audio apparatus is worn, the distance from the fourth sound outlet hole 16 to the antihelix is about 5 mm. In order to reduce the standing wave formed between the fourth sound outlet hole 16 and the antihelix, the ratio of the length of the fourth sound outlet hole 16 to the first surface 103 of the audio apparatus on the height direction is greater than 0.6.

In some implementations, the ratio of the length to the width of the fourth sound outlet hole 16 is not less than 2.5.

In order to illustrate the relationship between the sound outlet holes, the XYZ coordinate system is used for illustration. The projection regions of the sound outlet holes on the YZ plane are shown in FIG. 9. The distance between the projection centers of the first sound outlet hole 13 and the third sound outlet hole 15 on the YZ plane is 3 mm to 7 mm, and in some implementations, it is 4 mm. The distance between the projection centers of the first sound outlet hole 13 and the second sound outlet hole 14 on the YZ plane is 4 mm to 8 mm, and in some implementations, it is 6 mm. The distance between the projection centers of the second sound outlet hole 14 and the fourth sound outlet hole 16 on the YZ plane is 4 mm to 8 mm, and in some implementations, it is 6 mm. In a state that the audio apparatus is worn, as shown in FIG. 8, the fourth sound outlet hole 16 is toward the inferior crus of antihelix. In some implementations, the included angle between the direction of the fourth sound outlet hole 16 toward the inferior crus of antihelix and the above Z axis is 5° to 30°.

Due to the structure of the audio apparatus, the first sound outlet hole 13, the second sound outlet hole 14, the third sound outlet hole 15, and the fourth sound outlet hole 16 in the three-dimensional space should meet the conditions of the quadrupole sound source as much as possible to achieve the effect of preventing sound leakage. In order to optimize the spatial layout and better improve the leakage prevention capability, the sound source formed by the four sound outlet holes is made closer to the structure of the transverse quadrupole sound source in terms of spatial arrangement.

Referring to FIG. 4 to FIG. 9, it is a structural schematic diagram of the first sound outlet hole 13, the second sound outlet hole 14, the third sound outlet hole 15, and the fourth sound outlet hole 16 of the audio apparatus on a human ear auricle. The first sound outlet hole 13 and the second sound outlet hole 14 are disposed on the first surface 103 of the sound emitting portion 17. As shown in FIG. 8, two dotted racetrack-shaped small holes are the first sound outlet hole 13 and the second sound outlet hole 14, respectively. The third sound outlet hole 15 and the fourth sound outlet hole 16 are respectively disposed on the first side surface 1051 and the second side surface 1052. As shown in FIG. 8, two solid square-shaped small holes are the third sound outlet hole 15 and the fourth sound outlet hole 16, respectively. The long axes of the first sound outlet hole 13 and the second sound outlet hole 14 form an included angle of 0° to 120° with the plane where the short axis of the audio apparatus is located, and the included angle shown in the figure is 0°.

In some implementations, the vertical distance between the center of the fourth sound outlet hole 16 and the first edge 1054 is less than or equal to 10 mm, and the vertical distance between the center of the third sound outlet hole 15 and the second edge 1055 is less than or equal to 10 mm.

In some implementations, the center connection line of the first sound outlet hole 13 and the second sound outlet hole 14 forms an included angle that is between 25° and 70° with the YZ plane; forms an included angle that is less than or equal to 150° with the XY plane; and forms an included angle that is less than or equal to 150° with the XZ plane.

In some implementations, the included angle between the plane perpendicular to the average normal of the first sound outlet hole 13 and the YZ plane is less than or equal to 40°.

In some implementations, the included angle between the center connection line of the first sound outlet hole 13 and the sound outlet hole 2 and the plane formed by the upper ear root, the antihelix, and the tragus notch of the ear is less than or equal to 35°.

In some implementations, the included angle between the plane perpendicular to the average normal of the first sound outlet hole 13 and the plane formed by the upper ear root, the antihelix, and the tragus notch of the ear is less than or equal to 35°.

In some implementations, the center connection line of the third sound outlet hole 15 and the fourth sound outlet hole 16 forms an included angle of less than or equal to 40° with the ZY plane; forms an included angle of less than or equal to 150° with the XY plane; and forms an included angle of less than or equal to 150° with the XZ plane.

In some implementations, the included angle between the center connection line of the third sound outlet hole 15 and the fourth sound outlet hole 16 and the YZ plane, and the included angle between the plane perpendicular to the average normal of the third sound outlet hole 15 and the YZ plane are less than or equal to 82°. The included angle between the center connection line of the third sound outlet hole 15 and the fourth sound outlet hole 16 and the plane formed by the upper ear root, the antihelix, and the tragus notch of the ear is less than or equal to 35°.

In some implementations, the included angle between the center connection line of the third sound outlet hole 15 and the fourth sound outlet hole 16 and the plane formed by the notch between the upper ear root, the antihelix, and the tragus of the ear, and the included angle between the plane perpendicular to the average normal of the first sound outlet hole 13 and the plane formed by the upper ear root, the antihelix, and the tragus notch of the ear are less than or equal to 65°.

A part of the fourth sound outlet hole 16 is close to the antihelix, and a part of the fourth sound outlet hole 16 is close to the inferior crus of helix, and the distance to the antihelix is 3 mm. In order to reduce the standing wave formed between the fourth sound outlet hole 16 and the antihelix, the ratio of the length of the fourth sound outlet hole 16 to the first surface 103 of the audio apparatus in the height direction is greater than 0.6; or, the ratio of the length of the fourth sound outlet hole 16 to the first surface 103 of the audio apparatus in the length direction is greater than 0.6.

In some implementations, the ratio of the length to the width of the sound outlet hole of the second cavity 12 is not less than 2.5.

In order to illustrate the relationship between the sound outlet holes, the above-mentioned XYZ coordinate system is used for illustration.

The distance between the projection centers of the first sound outlet hole 13 and the third sound outlet hole 15 on the YZ plane is 4 mm. The distance between the projection centers of the first sound outlet hole 13 and the second sound outlet hole 14 on the YZ plane is 4 mm. The distance between the projection centers of the second sound outlet hole 14 and the fourth sound outlet hole 16 on the plane where the YZ axis is located is 4 mm.

The connection line between the projection centers of the third sound outlet hole 15 and the fourth sound outlet hole 16 on the YZ plane intersects with the connection line of the projections of the first sound outlet hole 13 and the second sound outlet hole 14 on the YZ plane to form an included angle, and the included angle is not greater than 90°.

The distance between the projection centers of the first sound outlet hole 13 and the third sound outlet hole 15 on the XY plane is 6 mm, the distance between the projection centers of the second sound outlet hole 14 and the fourth sound outlet hole 16 on the XY plane is 6 mm, and the distance between the projection centers of the first sound outlet hole 13 and the second sound outlet hole 14 on the XY plane is 3 mm.

The center connection line of the first sound outlet hole 13 and the third sound outlet hole 15 passes through the first diaphragm 21 of the speaker unit 20 and forms an included angle of less than or equal to 80° with the plane perpendicular to the vibration direction of the speaker unit 20, and in some implementations, it is less than or equal to 45°. The included angle between the connection line between the center of the first sound outlet hole 13 and the center of the third sound outlet hole 15 and the reference plane perpendicular to the average normal of the first sound outlet hole 13 is between 15° and 65°.

The center connection line of the second sound outlet hole 14 and the fourth sound outlet hole 16 passes through the first diaphragm 21 of the speaker unit 20 and forms an included angle of less than or equal to 80° with the plane perpendicular to the vibration direction of the speaker unit 20, and in some implementations, it is less than or equal to 45°. The included angle between the connection line between the center of the second sound outlet hole 14 and the center of the fourth sound outlet hole 16 and the reference plane perpendicular to the average normal of the second sound outlet hole 14 is 15° to 65°.

The fourth sound outlet hole 16 is toward the helix and the inferior crus of helix, and in some implementations, it is toward the antihelix. The included angle between the opening direction and the vertical axis of the user is 5° to 30°.

Based on the above solution, in a process of optimizing the spatial position of the quadrupole sound source, the position of the sound outlet hole is adjusted, and the solutions shown in FIG. 10 and FIG. 11 are possible. The positions of the first sound outlet hole 13, the second sound outlet hole 14, the third sound outlet hole 15, and the fourth sound outlet hole 16 may be designed according to actual design requirements.

One or more speaker units 20 are provided inside the audio apparatus. When the diaphragm of the speaker unit 20 vibrates, sound signals with the same amplitude and opposite phases are emitted in front of and behind the diaphragm.

The specific structure and the specific installation manner of the speaker unit 20 are as follows.

In this embodiment, as shown in FIG. 8 and FIG. 13, the speaker unit 20 is provided inside the sound emitting portion 17. The speaker unit 20 includes the first diaphragm 21, the second diaphragm 22, a voice coil, and the magnetic circuit assembly 26. The projection length of the long axis of the speaker unit 20 on the XY plane is greater than or equal to the projection length of the short axis of the speaker unit 20 on the XZ plane.

The first diaphragm 21 is bonded to the first voice coil 25, and after an alternating current signal is introduced into the first voice coil 25, the first voice coil 25 drives the first diaphragm 21 to vibrate under the driving of the magnetic circuit assembly 26. The first diaphragm 21 is closer to the ear opening than the second diaphragm 22.

The first diaphragm 21 and the inner wall of the first surface 103 and/or the inner wall of the side surface 105 of the sound emitting portion 17 form the first cavity 11. The sound signal generated by the first diaphragm 21 emits, through the first sound outlet hole 13 and the second sound outlet hole 14 of the first cavity 11, two sound signals with the same amplitude and the same phase. The second diaphragm 22 is bonded to the housing 10 of the speaker unit 20 and forms a completely sealed space with the housing 10 of the speaker unit 20 and the first diaphragm 21, and the space becomes the third cavity 28, where components such as the voice coil and the magnetic circuit assembly 26 are arranged in the third cavity 28, and the volume of the third cavity 28 is less than or equal to 8 cm³.

In this embodiment, as shown in FIG. 13, the second diaphragm 22 is a diaphragm of the speaker unit 20 and is not connected to the first voice coil 25, but the second diaphragm 22 vibrates in the same direction as the first diaphragm 21 under the driving of the first diaphragm 21. The vibration in the same direction is represented as: when the first diaphragm 21 vibrates in a direction away from the magnetic circuit assembly 26, the second diaphragm 22 vibrates in a direction toward the magnetic circuit assembly 26; on the contrary, when the first diaphragm 21 vibrates in the direction toward the magnetic circuit assembly 26, the second diaphragm 22 vibrates in the direction away from the magnetic circuit assembly 26.

The second diaphragm 22 and the inner wall and the side wall of the second surface 104 of the sound emitting portion 17 form the second cavity 12. The sound signal generated by the second diaphragm 22 is emitted through the third sound outlet hole 15 (not marked in the figure) and the fourth sound outlet hole 16 of the second cavity 12, and the sound waves of the two holes have the same amplitude and the same phase.

By adjusting the volume of the first cavity 11, the area of the first sound outlet hole 13 and the area of the second sound outlet hole 14, and the opening rate of the mesh cloth attached to the above sound outlet holes, the first sound outlet hole 13 and the third sound outlet hole 15 emit sounds with the same amplitude and opposite phases.

Similarly, by adjusting the volume of the second cavity 12, the area of the third sound outlet hole 15 and the area of the fourth sound outlet hole 16, and the opening rate of the mesh cloth attached to the above sound outlet holes, the second sound outlet hole 14 and the fourth sound outlet hole 16 emit sounds with the same amplitude and opposite phases.

The area of each of the first sound outlet hole 13, the second sound outlet hole 14, the third sound outlet hole 15, and the fourth sound outlet hole 16 is not less than 4 mm². When the opening area is relatively small, the radiation capability of the audio apparatus at middle and low frequencies is caused.

In some implementations, the area of the first sound outlet hole 13 is 0.4 to 2.5 times the area of the second sound outlet hole 14.

In some implementations, the area of the third sound outlet hole 15 is 0.4 to 2.5 times the area of the fourth sound outlet hole 16.

In some implementations, the area of the first sound outlet hole 13 is 0.4 to 2.5 times the area of the third sound outlet hole 15.

In some implementations, the area of the second sound outlet hole 14 is 0.4 to 2.5 times the area of the fourth sound outlet hole 16.

In some implementations, tuning mesh cloth may be attached to the first sound outlet hole 13, the second sound outlet hole 14, the third sound outlet hole 15, and the fourth sound outlet hole 16, and the acoustic resistance formed by the sound outlet holes and the acoustic mesh cloth is less than or equal to 9*109 Pa·s/m³.

In some implementations, the volume of each of the first cavity 11 and the second cavity 12 is greater than 0.8 cm³.

In some implementations, the volume of the first cavity 11 may be 0.4 to 6 times the volume of the second cavity 12.

In some implementations, the distance from the inner surface of the first cavity 11 to the diaphragm of the speaker unit 20 in the vibration direction of the speaker unit 20 is less than or equal to 3 mm.

As shown in FIG. 13, the first diaphragm 21 and the second diaphragm 22 both include a folded edge 211 and a vibrating portion 212. The vibrating portion 212 is a vibrating position of the first diaphragm 21 for vibrating to make a sound, and is generally an intermediate portion of the first diaphragm 21. The folded edge 211 is a transition portion between the edge portion of the first diaphragm 21 and the vibrating portion 212. Generally, the folded edge 211 is a raised or recessed inclined or arc structure, and is arranged circumferentially along the vibrating portion 212 of the first diaphragm 21. One side of the vibrating portion 212 is fixedly connected to the first voice coil 25, so that when a signal is introduced into the first voice coil 25, the voice coil moves under the action of the magnetic circuit assembly 26, thereby causing the first diaphragm 21 to vibrate and make a sound.

In some implementations, the first diaphragm 21 and the second diaphragm 22 both further include a fixing portion. The fixing portion is disposed on an outer edge of the folded edge 211 and is used for being fixed to the speaker unit 20 or the housing 10. In a vibration process of the first diaphragm 21, after the fixing portion is fixed, the vibrating portion 212 and the folded edge 211 form a suspension state, and therefore, the vibrating portion 212 moves under the action of the first voice coil 25, and the vibration amplitude and frequency are highly related to the folded edge 211.

As shown in FIG. 13, the first diaphragm 21 and the first voice coil 25 constitute a first vibration system, and the resonant frequency of the first vibration system is F1. The structure of the second diaphragm 22 is similar to that of the first diaphragm 21, but in this embodiment, the vibrating portion of the second diaphragm 22 is not connected to the first voice coil 25, and the vibration of the second diaphragm 22 is caused by the action of the first diaphragm 21, so that the second diaphragm 22 constitutes a second vibration system, and the resonant frequency of the second vibration system is F2. It is found through research that in order to achieve the same amplitude and opposite phases of the sound emitted by the first diaphragm 21 and the second diaphragm 22, the first vibration system and the second vibration system need to be controlled.

The resonant frequency of the vibration system is affected by the mass, elasticity, and internal damping of the system. The mass of the vibration system is affected by components such as the folded edge 211, the vibrating portion 212, and the first voice coil 25 and the like. The elasticity is affected by the material, thickness, and width of the folded edge 211 and the space sealed by the first diaphragm 21 and the second diaphragm 22. The internal damping is affected by the material of the folded edge 211. The sound radiation capability of the vibration system is affected by the displacement and area of the diaphragm.

The resonant frequency F1 of the first vibration system is close to the resonant frequency F2 of the second vibration system. In some implementations, the ratio of F1 to F2 ranges from 0.7 to 1.3.

The folded edge 211 of the second diaphragm 22 has smaller elastic force than the folded edge 211 of the first diaphragm 21. In some implementations, the ratio of the folded edge 211 of the second diaphragm 22 to folded edge 211 of the first diaphragm 21 in terms of thickness ranges from 0.88 to 2.2.

In some implementations, the folded edge 211 may be made of materials such as PU and liquid silica gel and the like.

In some implementations, the mass of the second vibration system is 0.1 to 2.2 times the mass of the first vibration system.

In some implementations, the internal damping of the second diaphragm 22 is 1.2 to 5 times the internal damping of the first diaphragm 21.

In some implementations, the area of the second diaphragm 22 is 0.8 to 2 times the area of the first diaphragm 21.

In some implementations, the center distance between the first sound outlet hole 13 and the first diaphragm 21 is 0.3 to 0.8 times the center distance between the second sound outlet hole 14 and the first diaphragm 21.

In some implementations, the center distance between the third sound outlet hole 15 and the second diaphragm 22 is 0.3 to 0.8 times the center distance between the fourth sound outlet hole 16 and the second diaphragm 22.

In another embodiment, as shown in FIG. 8 and FIG. 14. In this implementation case, the first vibration system includes the first diaphragm 21 and the first voice coil 25, and the second vibration system includes the second diaphragm 22 and the second voice coil 27. The second diaphragm 22 is sealed and fixed on the outer shell of the speaker unit 20, and the second voice coil 27 is fixed on one side of the second diaphragm 22. The first voice coil 25 and the second voice coil 27 are electrically connected in series. When the speaker unit 20 is in operation, when the same audio signal flows through the first voice coil 25 and the second voice coil 27, the first vibration system and the second vibration system vibrate in the same direction. At this time, the first diaphragm 21 and the second diaphragm 22 emit sounds with the same amplitude and opposite phases. The first diaphragm 21 and the second diaphragm 22 and the outer shell of the speaker unit 20 form a sealed space, and components such as the magnetic circuit assembly 26, the first voice coil 25, and the second voice coil 27 and the like of the speaker unit 20 are sealed in the space, and the space is less than or equal to 8 cm³. There are two magnetic circuit assemblies 26, which are a first magnetic circuit 261 and a second magnetic circuit 262, respectively. In some implementations, the space is less than or equal to 2 cm³.

The magnetic field of the magnetic circuit assembly 26 may have the same effect on both the first voice coil 25 and the second voice coil 27. When signals are introduced into the first voice coil 25 and the second voice coil 27, the currents in the first voice coil 25 and the second voice coil 27 are both affected by the magnetic field of the magnetic circuit assembly 26, causing the first voice coil 25 and the second voice coil 27 to reciprocate, so that the first voice coil 25 and the second voice coil 27 drive the first diaphragm 21 and the second diaphragm 22 to move in the same direction to make a sound.

The first vibration system and the second vibration system have close resonant frequencies, and in some implementations, the ratio of the resonant frequencies is 0.9 to 1.1.

The folded edge 211 of the second diaphragm 22 has smaller elastic force than the folded edge 211 of the first diaphragm 21, and in some implementations, the ratio of the folded edge 211 of the second diaphragm 22 to the folded edge 211 of the first diaphragm 21 in terms of thickness ranges from 0.88 to 1.2 times.

In some implementations, the mass of the second vibration system is 0.1 to 2.2 times the mass of the first vibration system; the internal damping of the second diaphragm 22 is 1.2 to 1.8 times the internal damping of the first diaphragm 21. The area of the second diaphragm 22 is 0.8 to 2 times the area of the first diaphragm 21.

In some implementations, the center distance between the first sound outlet hole 13 and the first diaphragm 21 is 0.3 to 0.8 times the center distance between the second sound outlet hole 14 and the first diaphragm 21.

In some implementations, the center distance between the third sound outlet hole 15 and the second diaphragm 22 is 0.3 to 0.8 times the center distance between the fourth sound outlet hole 16 and the second diaphragm 22.

In another embodiment, as shown in FIG. 8 and FIG. 15. In this implementation case, the implementation principle is similar to that of the embodiment in FIG. 13, and the second diaphragm 22 is a passive diaphragm, but is designed separately from the speaker unit 20, and the second diaphragm 22 is fixedly connected to the housing 10. The second diaphragm 22 is located on one side of the magnetic circuit assembly 26, between the magnetic circuit assembly 26 and the inner wall of the second surface 104. The second diaphragm 22 and the housing 10 of the audio apparatus are fixed by gluing and sealing. The first diaphragm 21 is a diaphragm of the speaker unit 20 and is located on a side opposite to the second diaphragm 22. The speaker unit 20 is sealed and fixed on the housing 10 of the audio apparatus, so that the first cavity 11 and the second cavity 12 are isolated from each other.

The first diaphragm 21 is a diaphragm inherent to the speaker unit 20, and the second diaphragm 22, as a separate diaphragm, forms a dual-diaphragm structure with the first diaphragm 21.

The first diaphragm 21 of the speaker unit 20, the second diaphragm 22, and the housing 10 of the audio apparatus form the third cavity 28 (the third cavity 28 is less than or equal to 18 cm³; in some implementations, the sealed space is 3 cm³), and components such as the voice coil and the magnetic circuit assembly 26 and the like of the speaker unit 20 are sealed therein to avoid external interference. When the first diaphragm 21 vibrates forward, that is, vibrates in a direction away from the magnetic circuit assembly 26, the second diaphragm 22 vibrates in a direction toward the magnetic circuit assembly 26. When the first diaphragm 21 vibrates backward, that is, vibrates in the direction toward the magnetic circuit assembly 26, the second diaphragm 22 vibrates in the direction away from the magnetic circuit assembly 26. The first diaphragm 21 and the second diaphragm 22 vibrate in the same direction to form sounds with the same amplitude and opposite phases.

The first vibration system and the second vibration system have close resonant frequencies, and in some implementations, the ratio of the resonant frequencies is 0.7 to 1.3 times.

The folded edge 211 of the second diaphragm 22 has smaller elastic force than the folded edge 211 of the first diaphragm 21, and in some implementations, the ratio of the folded edge 211 of the second diaphragm 22 to the folded edge 211 of the first diaphragm 21 in terms of thickness is 0.88 to 2.2 times.

In some implementations, the folded edge 211 is made of materials such as PU and liquid silica gel and the like.

In some implementations, the mass of the second vibration system is 0.1 to 2.2 times the mass of the first vibration system.

In some implementations, the internal damping of the second diaphragm 22 is 1.2 to 5 times the internal damping of the first diaphragm 21.

In some implementations, the area of the second diaphragm 22 is 0.8 to 2 times the area of the first diaphragm 21.

In some implementations, the center distance between the first sound outlet hole 13 and the first diaphragm 21 is 0.3 to 0.8 times the center distance between the second sound outlet hole 14 and the first diaphragm 21.

In some implementations, the center distance between the third sound outlet hole 15 and the second diaphragm 22 is 0.3 to 0.8 times the center distance between the fourth sound outlet hole 16 and the second diaphragm 22.

In another embodiment, as shown in FIG. 8 and FIG. 16, the second diaphragm 22 in the previous embodiment is removed, and the diaphragm inherent to the speaker unit 20 is used to form the first diaphragm 21. In this embodiment, the front side of the speaker unit 20 is opposite to the first cavity 11, and the rear end of the speaker unit 20 is opposite to the second cavity 12. The first cavity 11 and the second cavity 12 are isolated from each other. The first sound outlet hole 13 and the second sound outlet hole 14 are communicated with the first cavity 11, and the third sound outlet hole 15 (not marked in the figure) and the fourth sound outlet hole 16 are communicated with the second cavity 12. The first sound outlet hole 13 and the second sound outlet hole 14 are disposed on the first surface 103, and the third sound outlet hole 15 and the fourth sound outlet hole 16 are disposed on the second surface 104 or the side surface 105.

The diaphragm (i.e., the first diaphragm 21) of the speaker unit 20 is disposed on one side of the first mounting surface 101, and the rear side of the speaker unit 20 is disposed on one side of the second mounting surface 102. The magnetic circuit of the speaker unit 20 is the magnetic circuit assembly 26. The spatial relationships such as the size of the sound outlet hole and the size of the sound outlet hole and the diaphragm and the like in the previous embodiment may also constitute a quadrupole sound source for the audio apparatus in this embodiment, and the technology is also applicable.

In another embodiment, referring to the embodiment in FIG. 14, the speaker unit 20 is replaced with two speakers 201 and 202 each having only one diaphragm, as shown in FIG. 17. The first speaker 201 and the second speaker 202 are mounted back to back, the diaphragm of the first speaker 201 is disposed opposite to the first cavity 11, and the diaphragm of the second speaker 202 is disposed opposite to the second cavity 12. The sound emitted by the diaphragm of the first speaker 201 has the same amplitude and opposite phase as the sound emitted by the diaphragm of the second speaker 202. The diaphragm of the first speaker 201 is the first diaphragm 21, and the diaphragm of the second speaker 202 is the second diaphragm 22. The sound outlet holes of the first cavity 11 are the first sound outlet hole 13 and the second sound outlet hole 14, and the sound outlet holes of the second cavity 12 are the second sound outlet hole 15 and the fourth sound outlet hole 16.

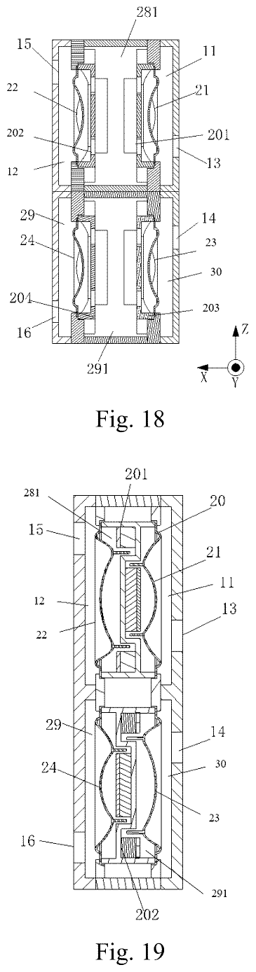

In another embodiment, as shown in FIG. 18, the speaker unit 20 includes a first speaker 201, a second speaker 202, a third speaker 203, and a fourth speaker 204, where each speaker includes a diaphragm. The diaphragms corresponding to the first speaker 201, the second speaker 202, the third speaker 203, and the fourth speaker 204 are a first diaphragm 21, a second diaphragm 22, a third diaphragm 23, and a fourth diaphragm 24, respectively.

Spatially, the first diaphragm 21, the second diaphragm 22, the third diaphragm 23, and the fourth diaphragm 24 may be back to back, or back to back side by side, or side by side on the same side.

The sound emitted by each sound outlet hole may be provided by an independent diaphragm radiating a sound signal outward. The first diaphragm 21 emits sound to the outside through the first sound outlet hole 13 coupled through the first cavity 11; the second diaphragm 22 is coupled through the second cavity 12 and emits a sound signal to the outside through the third sound outlet hole 15; the third diaphragm 23 is coupled through the seventh cavity 30 and emits a sound signal to the outside through the second sound outlet hole 14; and the fourth diaphragm 24 is coupled through the fourth cavity 29 and emits a sound signal to the outside through the fourth sound outlet hole 16.

The first diaphragm 21 and the second diaphragm 22 and the outer wall of the speaker unit 20 or the inner wall of the housing 10 form a sealed space, which is referred to as a fifth cavity 281. The magnetic circuit assemblies, the voice coils, etc. of the first speaker 201 and the second speaker 202 are sealed in the fifth cavity 281. The diaphragms of the first diaphragm 21 and the second diaphragm 22 may be driven in pairs, have the same vibration direction, and may emit sounds with the same amplitude and opposite phases.

The third diaphragm 23, the fourth diaphragm 24, and the outer wall of the third speaker 203, the fourth speaker 204, or the inner wall of the housing 10 form a sealed space, which is referred to as a sixth cavity 291. The magnetic circuit assemblies, the voice coils, etc. of the third speaker 203 and the fourth speaker 204 are sealed in the sealed space. The diaphragms of the third diaphragm 23 and the fourth diaphragm 24 may be driven in pairs, have the same vibration direction, and may emit sounds with the same amplitude and opposite phases.

The first diaphragm 21 and the third diaphragm 23 emit sounds with the same amplitude and the same phase; similarly, the second diaphragm 22 and the fourth diaphragm 24 emit sounds with the same amplitude and the same phase. The sound emitted by the diaphragm radiates outward through the four cavities and the sound outlet holes. The sound outlet hole 13 of the first cavity 11 and the sound outlet hole 15 of the second cavity 12 are analogous to the first sound outlet hole 13 and the third sound outlet hole 15 mentioned above, and the emitted sound constitutes a pair of dipole-like sound sources. The sound outlet hole 14 of the third cavity 30 and the sound outlet hole 16 of the fourth cavity 29 are analogous to the second sound outlet hole 14 and the fourth sound outlet hole 16 mentioned above, and the emitted sound constitutes a pair of dipole-like sound sources. And the two pairs of dipole-like sound sources constitute a quadrupole-like sound source. The parameters such as the size of the sound outlet hole, the position of the sound outlet hole, and the angle of the sound outlet hole and the like mentioned above are also applicable in this case.

In FIG. 18, the first diaphragm 21 and the second diaphragm 22 form the first cavity 11 and the second cavity 12 with the housing 10 through the speaker bracket, and the first diaphragm 21 and the second diaphragm 22 form the sealed fifth cavity 281 with the housing 10 through the speaker bracket;

The back side of the first diaphragm 21, that is, the side close to the magnet, is communicated with the fifth cavity 281 through the sound outlet hole on the speaker bracket; the back side of the second diaphragm 22, that is, the side close to the magnet, is communicated with the fifth cavity 281 through the sound outlet hole on the speaker bracket; and the first diaphragm 21 and the second diaphragm 22 may be driven in pairs to emit sounds with the same amplitude and opposite phases;

The third diaphragm 23 and the fourth diaphragm 24 form the seventh cavity 30 and the fourth cavity 29 with the housing 10 through the speaker bracket, and the third diaphragm 23 and the fourth diaphragm 24 form the sealed sixth cavity 291 with the housing 10 through the speaker bracket;

The back side of the third diaphragm 23, that is, the side close to the magnet, is communicated with the sixth cavity 291 through the sound outlet hole on the speaker bracket; the back side of the fourth diaphragm 24, that is, the side close to the magnet, is communicated with the sixth cavity 291 through the sound outlet hole on the speaker bracket; and the third diaphragm 23 and the fourth diaphragm 24 may be driven in pairs to emit sounds with the same amplitude and opposite phases;

As mentioned above, the volume of the fifth cavity 281 and the volume of the sixth cavity 291 cannot be too large, and in some implementations, they are less than or equal to 8 cm³, and more preferably, less than or equal to 3 cm³.

In order to achieve a good acoustic quadrupole effect, the vibration systems of the first speaker 201, the second speaker 202, the third speaker 203, and the fourth speaker 204 are close in resonant frequency.

The speaker unit 20 or the passive diaphragm provides the vibration system. The first vibration system is provided by the first speaker unit 201, the second vibration system is provided by the second speaker unit 202, the third vibration system is provided by the third speaker unit 203, and the fourth vibration system is provided by the fourth speaker unit 204.

The first vibration system and the second vibration system have close resonant frequencies, and specifically, the ratio of the resonant frequencies is 0.7 to 1.3.

The third vibration system and the fourth vibration system have close resonant frequencies, and specifically, the ratio of the resonant frequencies is 0.7 to 1.3.

The second vibration system and the fourth vibration system have close resonant frequencies, and specifically, the ratio of the resonant frequencies is 0.7 to 1.3.

The folded edge 211 of the third diaphragm 23 has close compliance to the folded edge 211 of the first diaphragm 21. Specifically, the ratio of the folded edge 211 of the third diaphragm 23 to the folded edge 211 of the first diaphragm 21 in terms of thickness is 0.88 to 2.2.

Specifically, the folded edge 211 is made of materials such as PU and liquid silica gel and the like.

Preferably, the mass of the fourth vibration system is 0.1 to 2.2 times the mass of the second vibration system.

Preferably, the internal damping of the fourth diaphragm 24 is 0.5 to 5 times the internal damping of the second diaphragm 22.

Preferably, the area of the fourth diaphragm 24 is 0.8 to 2 times the area of the second diaphragm 22.

The folded edge 211 of the second diaphragm 22 has close compliance to the folded edge 211 of the first diaphragm 21, and preferably, the ratio of the folded edge 211 of the second diaphragm 22 to the folded edge 211 of the first diaphragm 21 in terms of thickness is 0.9 to 1.1.

Specifically, the folded edge 211 is made of materials such as PU and liquid silica gel and the like.

Specifically, the mass of the second vibration system is 1.05 to 1.2 times the mass of the first vibration system.

Specifically, the internal damping of the third diaphragm 23 is 0.9 to 1.1 times the internal damping of the first diaphragm 21.

Specifically, the area of the second diaphragm 22 is close to the area of the first diaphragm 21.

In this embodiment, the related parameters of the first cavity 11 and the sound outlet hole 13 thereof, the seventh cavity 30 and the sound outlet hole 14 thereof, the second cavity 12 and the sound outlet hole 15 thereof, and the fourth cavity 24 and the sound outlet hole 16 thereof are the same as those in the embodiment shown in FIG. 14, and are not repeated herein.

In some embodiments, referring to the embodiment in FIG. 18, it may be easily conceived to replace the second speaker 203 and the fourth speaker 204 with passive diaphragms, and the passive diaphragms may be fixed on the housing of the audio apparatus by gluing and sealing, and the effect in the embodiment in FIG. 18 may be achieved by adjusting the mass, compliance, and internal damping of the passive diaphragms.

In another embodiment, as shown in FIG. 19, referring to the embodiment shown in FIG. 19, two speakers may be replaced with a single speaker with dual magnetic circuits and dual diaphragms through design. Specifically, the speaker unit 20 includes two speakers having two diaphragms. The speaker unit 20 includes a first speaker 201 and a second speaker 202, where the first speaker 201 has a first diaphragm 21 and a second diaphragm 22, and the second speaker 202 has a third diaphragm 23 and a fourth diaphragm 24. The first diaphragm 21 and the second diaphragm 22 and a bracket of the first speaker 201 form a sealed space 281, the magnetic circuit system is located in the sealed space, the third diaphragm 223 and the fourth diaphragm 24 and the second speaker 202 form a sealed space 291, and the magnetic circuit system is located in the sealed space.

The volume of the sealed space is less than or equal to 8 cm³, and preferably, less than or equal to 3 cm³.

The first vibration system is provided by the first diaphragm 21 and the voice coil attached thereto, the second vibration system is provided by the second diaphragm 22 and the voice coil attached thereto, the third vibration system is provided by the third diaphragm 23 and the voice coil attached thereto, and the fourth vibration system is provided by the fourth diaphragm 24 and the voice coil attached thereto. The related vibration system technology is similar to that in the embodiment shown in FIG. 19, and is not described in detail here.

In this embodiment, the related parameters of the first cavity 11 and the sound outlet hole 13 thereof, the second cavity 12 and the sound outlet hole 15 thereof, the seventh cavity 30 and the sound outlet hole 14 thereof, the fourth cavity 24 and the sound outlet hole 16 thereof, the fifth cavity 281, and the sixth cavity 291 are the same as those in the embodiment shown in FIG. 14, and are not repeated herein. Through the implementation of the acoustic quadrupole in the above solution, compared with the acoustic dipole, it has achieved better improvement in both the acoustic far-field sound leakage and the near-field listening.

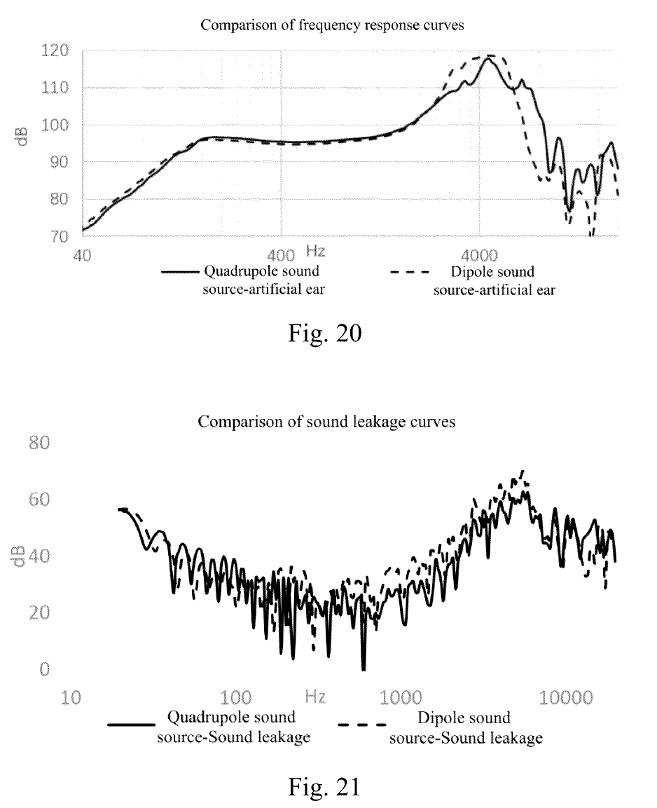

As shown in FIG. 20, compared with the dipole, the quadrupole has better audio playback effect and sound leakage prevention effect.

As shown in FIG. 21, which is a comparison of sound leakage curves, the higher the sound pressure level of the frequency response curve, the more the leaked sound. The solid line is the curve of the sound leakage prevention capability of the quadrupole sound source solution, and the dotted line is the curve of the sound leakage prevention capability of the dipole sound source solution. Obviously, in the frequency band of 300 Hz to 6000 Hz that is sensitive to human ears, the quadrupole sound source solution has a better capability of preventing sound leakage.

The hook-shaped portion of the audio apparatus illustrated in this case is configured to be hooked on the ear and to allow the sound emitting portion 17 to be close to the front side of the auricle, and the hook-shaped portion may be connected by the headband portion or the neckband portion. The headband portion or the neckband portion connects the audio apparatuses of the left and right ears, so that the audio apparatuses are integrally worn on the head.

The headband portion or the neckband portion is formed of a plastic material, and the plastic material may be polyethylene (PE), polypropylene (PP), polyvinyl chloride (PVC), polystyrene (PS), acrylonitrile-butadiene-styrene copolymer (ABS), silica gel, etc. The memory titanium wire may be disposed in the plastic-formed headband portion or neckband portion by plastic injection molding or post-assembly, and is used for adjusting the clamping force of the headband portion or the neckband portion to adjust wearing comfort.

Compared with the prior art, in the present application, the first cavity 11 and the second cavity 12 are provided at the front end and the rear end of the speaker unit 20, and the first cavity 11 is provided with the first sound outlet hole 13 and the second sound outlet hole 14, and the second cavity 12 is provided with the third sound outlet hole 15 and the fourth sound outlet hole 16. The sound emitted from the first sound outlet hole 13 and the second sound outlet hole 14 has the same amplitude and opposite phase as the sound emitted from the third sound outlet hole 15 and the fourth sound outlet hole 16, thereby forming a multipole sound source. The connection line of the center positions of the projections of the first sound outlet hole 13, the second sound outlet hole 14, the third sound outlet hole 15, and the fourth sound outlet hole 16 on the plane perpendicular to the vibration direction of the diaphragm constitutes a quadrilateral. The multipole sound source has a better attenuation for the middle and low frequency bands, especially the middle frequency band that is sensitive to human ears. When the multipole sound source is used in a non-invasive audio apparatus, sound leakage may be effectively prevented, thereby improving user privacy.

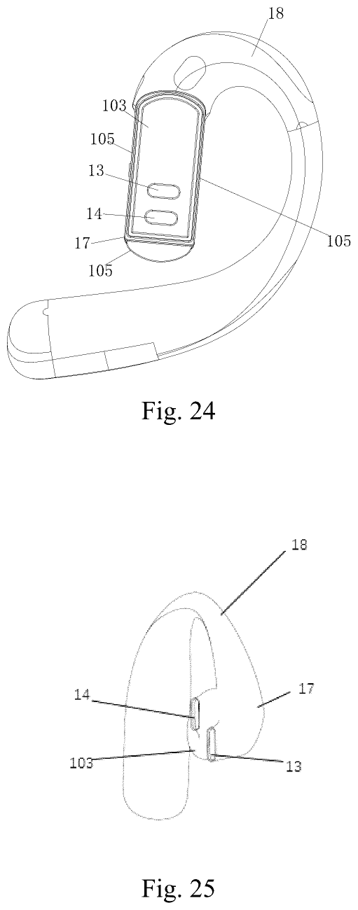

The present application further provides an audio apparatus, as shown in FIG. 17 to FIG. 35, in an embodiment of the present application, the audio apparatus includes a sound emitting portion 17, and the sound emitting portion 17 includes a housing 10 and at least one speaker unit 20. The speaker unit 20 includes at least one diaphragm. The speaker unit 20 is disposed inside the cavity formed by the structural member, that is, the speaker unit 20 is disposed inside the cavity formed by the housing 10. A cavity is provided between the vibrating outer surface of the diaphragm and the inner wall of the housing 10, and a cavity is also provided between the side of the speaker unit 20 away from the diaphragm and the housing 10, and each of the two cavities is provided with at least two sound outlet holes. The diaphragm radiates a sound signal to the cavity on the same side, and similarly, the cavity on the side away from the diaphragm is subject to coupling effects, so that the sound signals radiated from the sound outlet holes of the two cavities have the same amplitude and opposite phases.

The two cavities are named as a first cavity 11 and a second cavity 12, respectively. The first cavity 11 and the second cavity 12 are sound transmission cavities for the diaphragm to vibrate and make a sound, and then the sound is propagated through the sound outlet holes.

In an embodiment, the speaker unit 20 is provided with one diaphragm, the first cavity 11 is provided on one side of the diaphragm, and the second cavity 12 is provided on the other side away from the diaphragm. Through the action of the internal coupling structure of the speaker unit 20, the sound signals emitted from the sound outlet holes by the first cavity 11 and the second cavity 12 have the same amplitude and opposite phases. In this case, one speaker is provided in the housing 10, and the speaker has one diaphragm, as shown in FIG. 34.

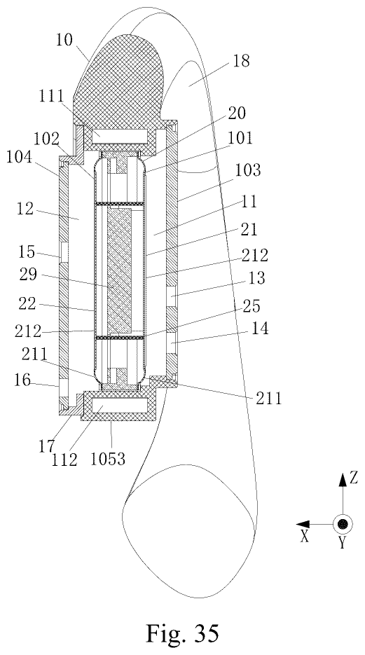

In an embodiment, the speaker unit 20 is provided with two diaphragms, which are a first diaphragm 21 and a second diaphragm 22, respectively. The first diaphragm 21 corresponds to the first cavity 11, and the second diaphragm 22 corresponds to the second cavity 12. The sound signals radiated by the vibration of the first diaphragm 21 and the second diaphragm 22 have the same amplitude and opposite phases. The design of two diaphragms may be implemented in the following manners.
1. It is provided by a speaker unit 20 with dual diaphragms and dual voice coils, as shown in FIG. 32. The first diaphragm 21 is fixedly connected to one of the voice coils (the first voice coil 25), and the second diaphragm 22 is fixedly connected to the other voice coil (the second voice coil 27). The two voice coils drive respective diaphragms to emit sound signals with the same amplitude and opposite phases. Specifically, the dual-diaphragm dual voice coil speaker unit 20 is in a series relationship in electrical connection.
2. It is provided by a speaker unit 20 with dual diaphragms and a single voice coil, as shown in FIG. 34. The first diaphragm 21 and the second diaphragm 22 are both fixed to the same voice coil, and the first diaphragm 21 and the second diaphragm 22 emit sound signals with the same amplitude and opposite phases through a coupling mechanism.
3. It is provided by two speaker units 20, as shown in FIG. 35. One speaker unit 20 is provided with the first diaphragm 21, and the other speaker unit 20 is provided with the second diaphragm 22, that is, the first diaphragm 21 and the second diaphragm 22 are both diaphragms on the two speaker units 20. By controlling the current of the control circuit, the first diaphragm 21 and the second diaphragm 22 of the two speaker units 20 emit sound signals with the same amplitude and opposite phases.
4. It is provided by a speaker unit 20 and a passive diaphragm, as shown in FIG. 32. The speaker unit 20 is provided with a diaphragm, or the passive diaphragm is fixedly bonded to the housing of the audio apparatus. The diaphragm of the speaker unit 20 and the passive diaphragm form a sealed space with the housing of the speaker or the housing of the audio apparatus. When the diaphragm of the speaker unit 20 vibrates, the space of the sealed space is pushed to vibrate, and then the passive diaphragm and the diaphragm of the speaker unit 20 move in the same direction, thereby emitting sound signals with approximately the same amplitude and opposite phases. As shown in FIG. 32, a first assembly surface 101 and a second assembly surface 102 are provided inside the housing 10 of the audio apparatus of the present application. The speaker unit 20 is fixed inside the housing 10 and located between the first assembly surface 101 and the second assembly surface 102, so that the first diaphragm 21 is mounted on the first assembly surface 101, and the second diaphragm 22 is mounted on the second assembly surface 102. Other components of the speaker unit 20 are arranged in a cavity between the first assembly surface 101 and the second assembly surface 102.

In other embodiments, the surface connecting the first assembly surface 101 and the second assembly surface 102 is referred to as an inner side surface. The first diaphragm 21 or the second diaphragm 22 may be provided on the inner side surface according to actual needs.

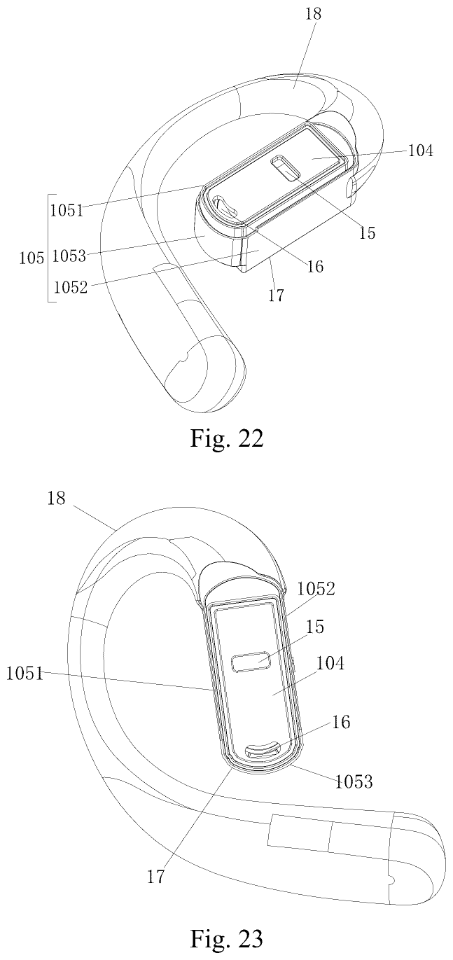

As shown in FIG. 22 to FIG. 24 and FIG. 32, the outer surface of the housing 10 includes a first surface 103, a second surface 104, and a side surface 105. The first surface 103 is disposed close to the ear hole, and the second surface 104 is disposed toward the outer side. An outer surface of the first cavity 11 is the first surface 103, and an outer surface of the second cavity 12 is the second surface 104. The side surface 105 is a side surface connecting the first surface 103 and the second surface 104. For a more detailed distinction, the side surface 105 includes a first side surface 1051, a second side surface 1052, and a third side surface 1053. The third side surface 1053 is a side surface connecting the first surface 103 and the second surface 104 at the bottom of the housing 10. The first side surface 1051 and the second side surface 1052 are side surfaces respectively disposed on two sides of the third side surface 1053, and the first side surface 1051 and the second side surface 1052 are connected to the side edges of the first surface 103 and the second surface 104.

The first cavity 11 corresponding to the first diaphragm 21 is provided with at least two sound outlet holes, and in the present application, there are two sound outlet holes, which are a first sound outlet hole 13 and a second sound outlet hole 14, respectively. The first sound outlet hole 13 and the second sound outlet hole 14 may be located on the first surface 103 of the product at the same time, or on the side surface 105 at the same time, or respectively on the first surface 103 and the side surface 105, or on the second surface 104 at the same time, or respectively on the second surface 104 and the side surface 105. The positions of the first sound outlet hole 13 and the second sound outlet hole 14 are set according to the needs of an actual product.

As shown in FIG. 22 to FIG. 24 and FIG. 32, the second cavity 12 corresponding to the second diaphragm 22 is provided with at least two sound outlet holes, and in the present application, there are two sound outlet holes, which are a third sound outlet hole 15 and a fourth sound outlet hole 16, respectively. The third sound outlet hole 15 and the fourth sound outlet hole 16 may be located on the second surface 104 of the product at the same time, or on the side surface 105 at the same time, or respectively on the second surface 104 and the side surface 105, or on the first surface 103 at the same time, or respectively on the first surface 103 or the side surface 105. The positions of the third sound outlet hole 15 and the fourth sound outlet hole 16 are set according to the needs of the actual product.

In an embodiment, the first sound outlet hole 13 and the third sound outlet hole 15 constitute a dipole sound source, and the second sound outlet hole 14 and the fourth sound outlet hole 16 constitute a dipole sound source. In space, two pairs of dipole sound sources with opposite phases and the same amplitude are relatively close to each other, forming a longitudinal quadrupole sound source with a polarity of “− + + −”.

In this embodiment, the first cavity 11 is directly communicated with the outside through the first sound outlet hole 13 and the second sound outlet hole 14, that is, the sound is directly radiated to the outside after passing through the first cavity 11; similarly, the third sound outlet hole 15 and the fourth sound outlet hole 16 also directly radiate sound to the outside through the second cavity 12, which may reduce the energy loss of the sound wave in the propagation process.

In other embodiments, the first sound outlet hole 13 and the second sound outlet hole 14 are not directly communicated with the first cavity 11, and the first sound outlet hole 13 and the second sound outlet hole 14 are communicated with the first cavity 11 through a first sound guide tube according to design requirements. The first sound guide tube may be a straight tube or a curved tube, so the channel of the first sound guide tube may be linear or circuitous, which is selected according to actual design requirements.

In other embodiments, the third sound outlet hole 15 and the fourth sound outlet hole 16 are not directly communicated with the second cavity 12, and the third sound outlet hole 15 and the fourth sound outlet hole 16 are communicated with the second cavity 12 through a second sound guide tube according to design requirements. The second sound guide tube may be a straight tube or a curved tube, so the channel of the second sound guide tube may be linear or circuitous, which is selected according to actual design requirements.

The first diaphragm 21, the second diaphragm 22, and the mounting shell of the speaker unit 20 form a sealed space, which is referred to as a third cavity 28. Components such as the voice coil, the magnet, and the magnetic conductive plate and the like are completely sealed in the third cavity 28, which may provide a waterproof function. Specifically, the volume of the third cavity 28 does not exceed 8 cm³.

In some embodiments, the first diaphragm 21 and the second diaphragm 22 may form a sealed space with the product housing 10, which is a fourth cavity 29. The function of this sealed space is similar to that of the third cavity 28, so that components such as the magnetic circuit assembly 26 like the voice coil and the magnet conductive plate etc. and the outer shell bracket of the speaker unit 20 and the like behind the diaphragm are completely sealed in the space. Since this sealed space seals the outer shell bracket of the speaker unit, the space is relatively large. Specifically, the volume of the sealed space does not exceed 18 cm³.

In space, the first diaphragm 21 and the second diaphragm 22 may be back to back, or back to back side by side or side by side on the same side.

The vibration direction of the diaphragm is a direction perpendicular to the effective vibration area of the diaphragm.

The first sound outlet hole 13, the second sound outlet hole 14, the third sound outlet hole 15, and the fourth sound outlet hole 16 are respectively projected on a plane perpendicular to the vibration direction of the diaphragm to form a first projection region 131, a second projection region 141, a third projection region 151, and a fourth projection region 161.

The center distance between the first projection region 131 and the second projection region 141 is less than or equal to 25 mm, and the first sound outlet hole 13 and the second sound outlet hole 14 emit sounds with the same amplitude and the same phase.

Specifically, the center distance between the third projection region 151 and the first projection region 131 is less than or equal to 15 mm.

Specifically, the third sound outlet hole 15 is projected on a plane parallel to the vibration direction of the diaphragm of the speaker unit 20, and the first sound outlet hole 13 is projected on the plane parallel to the vibration direction of the diaphragm of the speaker unit 20. The center distance between the above two projections is less than 13 mm.

Specifically, the center distance between the first sound outlet hole 13 and the third sound outlet hole 15 is less than or equal to 20 mm.

The third sound outlet hole 15 and the first sound outlet hole 13 emit sounds with the same amplitude and opposite phases. The first sound outlet hole 13 is closer to the ear hole than the second cavity 12 and the third sound outlet hole 15, and the distance from the first sound outlet hole 13 to the ear hole of the auricle is less than or equal to 15 mm.

The center distance between the third projection region 151 and the fourth projection region 161 is less than or equal to 25 mm, and the third sound outlet hole 15 and the fourth sound outlet hole 16 emit sounds with the same amplitude and the same phase.

Specifically, the center distance between the fourth projection region 161 and the second projection region 141 is less than or equal to 15 mm.

Specifically, the fourth sound outlet hole 16 is projected on a plane parallel to the vibration direction of the diaphragm of the speaker unit 20, and the second sound outlet hole 14 is projected on the plane parallel to the vibration direction of the diaphragm of the speaker unit 20. The center distance between the above two projections is less than 13 mm.

Specifically, the center distance between the first sound outlet hole 13 and the third sound outlet hole 15 is less than or equal to 20 mm.

Specifically, the fourth sound outlet hole 16 and the second sound outlet hole 14 emit sounds with the same amplitude and opposite phases.

When the audio apparatus is worn on the auricle, the second sound outlet hole 14 is farther from the ear hole than the first sound outlet hole 13 and closer to the cymba conchae. The distance between the second sound outlet hole 14 and the cymba conchae is less than or equal to 10 mm, and the third sound outlet hole 15 is closer to the opening of the auricle than the fourth sound outlet hole 16.

Specifically, the first projection region 131 and the second projection region 141 are located on a straight line where the connection line between the center point of the third projection region 151 and the center point of the fourth projection region 161 is located, or on the same side of the straight line where the connection line between the center point of the third projection region 151 and the center point of the fourth projection region 161 is located, forming an acoustic quadrupole of “− + + −” arranged in a line in space.

In the wearing state, the first sound outlet hole 13 and the second sound outlet hole 14, and the third sound outlet hole 15 and the fourth sound outlet hole 16 are located between the antitragus, the antihelix, the tragus, and the inferior crus of antihelix.

The opening direction of the fourth sound outlet hole 16 is toward the auricle. Specifically, the fourth sound outlet hole 16 is opened toward the inferior crus of antihelix, the antihelix, and the antitragus. The closest distance between the center of the fourth sound outlet hole 16 and the antihelix is between 2 mm and 10 mm, the closest distance between the fourth sound outlet hole 16 and the inferior crus of antihelix is between 3 mm and 12 mm, the closest distance between the fourth sound outlet hole 16 and the antitragus is between 2 mm and 7 mm, and the included angle between the fourth sound outlet hole 16 and the vertical axis of the user is 10° to 35°. Due to the diversity of the auricles of users, this angle may prevent the fourth sound outlet hole 16 from being blocked when the user wears the audio apparatus.

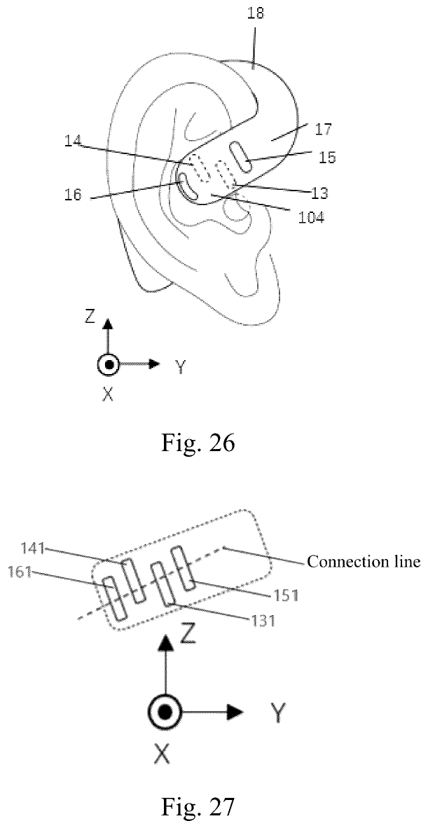

As shown in FIG. 3, FIG. 22 to FIG. 32, the part of the audio apparatus exposed on the front side of the auricle is defined as a sound emitting portion 17, and the part between the rear side of the auricle, that is, between the auricle and the head side, is defined as a hook-shaped band 18, where the hook-shaped band 18 is connected to the sound emitting portion 17. In order to more clearly describe the relationship between the audio apparatus and the human ear, an XYZ three-dimensional space coordinate is defined with the ear canal entrance as the origin. As shown in FIG. 26 and FIG. 29, the direction outward from the ear canal entrance is defined as the positive X half-axis and also defined as the thickness direction, the direction upward from the ear canal entrance and toward the top of the head is defined as the positive Z half-axis and also defined as the height direction, and the direction from the ear canal entrance toward the face is defined as the positive Y half-axis. The YZ plane of the XYZ space coordinate is perpendicular to the vibration direction of the speaker diaphragm.

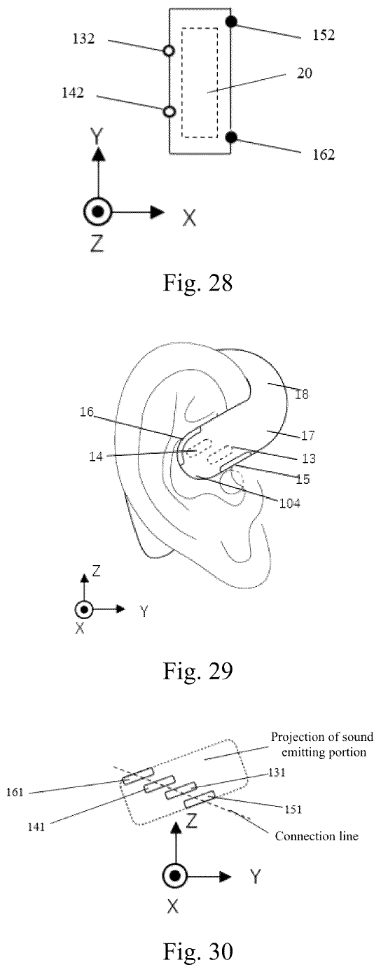

Referring to FIG. 27 and FIG. 28, in order to illustrate the relationship between the sound outlet holes, the above-mentioned XYZ coordinate system is used for illustration. The projections of the sound outlet holes on the YZ plane are shown in FIG. 27, and the projections of the sound outlet holes on the XY plane are shown in FIG. 28. The first sound outlet hole 13, the second sound outlet hole 14, the third sound outlet hole 15, and the fourth sound outlet hole 16 are respectively projected on a plane perpendicular to the vibration direction of the diaphragm to form a first projection region 131, a second projection region 141, a third projection region 151, and a fourth projection region 161.

The first sound outlet hole 13 is projected on the XY plane to form a fifth projection region 132, the second sound outlet hole 14 is projected on the XY plane to form a sixth projection region 142, the third sound outlet hole 15 is projected on the XY plane to form a seventh projection region 152, and the fourth sound outlet hole 16 is projected on the XY plane to form an eighth projection region 162.

Although the auricles of each person may be different, which may cause differences in the wearing state of the apparatus, the sound leakage prevention effect of the apparatus may be maximized only when the sound outlet of the apparatus is placed at the ear canal entrance.

The audio apparatus is worn on the auricle through the hook-shaped band 18, and the sound emitting portion 17 is located on the front side of the auricle. The sound emitting portion 17 has a long axis and a short axis that are orthogonal to each other in a direction perpendicular to the vibration direction of the diaphragm of the speaker unit 20. The long axis of the sound emitting portion 17 is projected on the YZ plane to form a certain included angle with the Y axis. Specifically, the included angle is 15° to 50°. More specifically, the included angle is between 35° and 50°. This angle defines the position of the speaker unit on the auricle, so that the speaker may cover the auricle as much as possible, and the placement angle of the speaker conforms to the shape and ergonomics of the product.

In order to further illustrate the position of the sound emitting portion 17 on the auricle, the audio apparatus has a second side surface 1052 intersecting with the first surface 103, that is, a common side edge of the second side surface 1052 and the first surface 103, to form a first edge. The part of the first edge close to the connecting portion is higher than the tragus tubercle in the height direction. This design avoids excessive contact between the audio apparatus and the tragus tubercle, thereby avoiding discomfort caused when the audio apparatus is worn. The third side surface 1053 is disposed opposite to the second side surface 1052 to form a tetrahedron-like structure in this embodiment, but it is not limited to this structure and may also be circular, elliptical, etc. A second edge is formed at the connection between the third side surface 1053 and the first surface 103. A partial position of the second edge contacts the intersection region of the upper ear root and the helix.

The projection of the audio apparatus along the thickness direction (the X-axis direction) may cover the cymba conchae, the crus of helix, and part of the cavum conchae and part of the ear canal opening. The third side surface 1053 of the sound emitting portion 17 is set as arc-shaped in the height direction (the Z-axis direction in FIG. 26), and the arc radius is not less than 6.3 mm. The third side surface 1053 is far from the ear canal opening and close to the antihelix, and the distance from the third side surface 1053 to the antihelix is not less than 2 mm.

As shown in FIG. 26 and FIG. 29, it is a structural schematic diagram of the first sound outlet hole 13, the second sound outlet hole 14, the third sound outlet hole 15, and the fourth sound outlet hole 16 of the audio apparatus on a human ear auricle. The first sound outlet hole 13 and the second sound outlet hole 14 are disposed on the first surface 103 of the sound emitting portion 17, as shown by dotted racetrack-shaped holes in FIG. 26. The third sound outlet hole 15 and the fourth sound outlet hole 16 are disposed on the second surface 104 of the sound emitting portion 17, as shown by solid racetrack-shaped holes in FIG. 26.

The long axes of the first sound outlet hole 13 and the second sound outlet hole 14 form an included angle of 0° to 120° with the plane where the short axis of the audio apparatus is located, and the included angle is 0° in FIG. 26 of this embodiment.

As shown in FIG. 25, a convex structure 106 is provided on the first surface 103 of the audio apparatus toward the cavum conchae. The first sound outlet hole 13 and the second sound outlet hole 14 are disposed on an end surface of the convex structure 106. The convex structure 106 is higher than the first surface 103. Specifically, the height of the convex structure 106 higher than the first surface 103 is 0.5 mm to 3 mm. The convex structure 106 where the first sound outlet hole 13 is located is higher than the convex structure 106 where the second sound outlet hole 14 is located relative to the first surface 103 by at least 0.5 mm, that is, the height of the convex structure 106 is matched with the structure of the auricle according to the audio apparatus, so that more sound may be transmitted into the ear hole.

After the audio apparatus is normally worn, the center connection line of the first sound outlet hole 13 and the second sound outlet hole 14 of the audio apparatus forms an included angle of 25° to 70° with the YZ plane of the above coordinate system; forms an included angle of less than or equal to 150° with the XY plane; and forms an included angle of less than or equal to 150° with the XZ plane.

In other embodiments, after the audio apparatus is normally worn, the included angle between the plane perpendicular to the average normal of the first sound outlet hole 13 and the YZ plane is less than or equal to 40°.

In other embodiments, the included angle between the center connection line of the first sound outlet hole 13 and the second sound outlet hole 14 and the plane formed by the ear root, the antihelix, and the tragus notch of the auricle is less than or equal to 35°.

In other embodiments, the included angle between the plane perpendicular to the average normal of the first sound outlet hole 13 and the plane formed by the upper ear root, the antihelix, and the tragus notch of the auricle is less than or equal to 35°.

The center connection line of the third sound outlet hole 15 and the fourth sound outlet hole 16 forms an included angle of less than or equal to 40° with the ZY plane; forms an included angle of less than or equal to 150° with the XY plane; and forms an included angle of less than or equal to 150° with the XZ plane.

The included angle between the plane perpendicular to the average normal of the third sound outlet hole 15 and the YZ plane is less than or equal to 82°.

The included angle between the center connection line of the third sound outlet hole 15 and the fourth sound outlet hole 16 and the plane formed by the upper ear root, the antihelix, and the tragus notch of the auricle is less than or equal to 35°.

The included angle between the plane perpendicular to the average normal of the first sound outlet hole 13 and the plane formed by the upper ear root, the antihelix, and the tragus notch of the auricle is less than or equal to 65°.

The fourth sound outlet hole 16 is opened toward the antihelix, and the distance from the fourth sound outlet hole 16 to the antihelix is about 5 mm after the audio apparatus is worn. In order to reduce the standing wave formed between the fourth sound outlet hole 16 and the antihelix, the ratio of the length of the fourth sound outlet hole 16 to the first surface 103 of the audio apparatus in the height direction is greater than 0.6.

Specifically, the ratio of the length to the width of the sound outlet hole of the second cavity 12 is not less than 2.5.

In order to illustrate the relationship between the sound outlet holes, the XYZ coordinate system is still used for illustration. The projections of the sound outlet holes on the YZ plane and the XY plane are shown in FIG. 29. The distance between the projection centers of the first sound outlet hole 13 and the third sound outlet hole 15 on the YZ plane is 3 mm to 7 mm, specifically 4 mm. The distance between the projection centers of the first sound outlet hole 13 and the second sound outlet hole 14 on the YZ plane is 4 mm to 8 mm, specifically 6 mm. The distance between the projection centers of the second sound outlet hole 14 and the fourth sound outlet hole 16 on the YZ plane is 4 mm to 8 mm, specifically 6 mm.

In this case, the YZ plane is perpendicular to the vibration direction of the speaker diaphragm, so as shown in FIG. 27 to FIG. 31, the projections of the third sound outlet hole 15 and the fourth sound outlet hole 16 on the YZ plane are the aforementioned third projection region 151 and the fourth projection region 161, and the projections of the first sound outlet hole 13 and the second sound outlet hole 14 on the YZ plane are the aforementioned first projection region 131 and the second projection region 141. The first projection region 131 and the second projection region 141 are on the center connection line of the third projection region 151 and the fourth projection region 161.

A midpoint of a connection line between the center point of the first projection region 131 and the center point of the third projection region 151 is set as a first midpoint, and a midpoint of a connection line between the center point of the second projection region 141 and the center point of the third projection region 151 is set as a second midpoint. The range of the distance between the first midpoint and the second midpoint is 7 mm to 25 mm.

The range of the difference between the distance between the center points of the first projection region 131 and the third projection region 151 and the distance between the center points of the second projection region 141 and the third projection region 151 is 0 mm to 5 mm.

The distance between the projection centers of the first sound outlet hole 13 and the third sound outlet hole 15 on the XY plane is 6 mm to 10 mm, specifically 8 mm, and the distance between the projection centers of the second sound outlet hole 14 and the fourth sound outlet hole 16 on the XY plane is 6 mm to 10 mm, specifically 8 mm. The distance between the projection centers of the first sound outlet hole 13 and the second sound outlet hole 14 on the XY plane is 3 mm to 7 mm, specifically 5 mm.

The center connection line of the first sound outlet hole 13 and the third sound outlet hole 15 passes through the first diaphragm 21 of the speaker unit 20 and forms an included angle of less than or equal to 80° with the plane perpendicular to the vibration direction of the speaker unit 20.

The included angle between the center connection line of the first sound outlet hole 13 and the third sound outlet hole 15 and the plane perpendicular to the average normal of the first sound outlet hole 13 is 15° to 75°.

The center connection line of the second sound outlet hole 14 and the fourth sound outlet hole 16 passes through the first diaphragm 21 of the speaker unit 20 and forms an included angle of less than or equal to 80° with the plane perpendicular to the vibration direction of the speaker unit 20.

The included angle between the center connection line of the second sound outlet hole 14 and the fourth sound outlet hole 16 and the plane perpendicular to the average normal of the second sound outlet hole 14 is 15° to 75°.

In a state that the audio apparatus is worn, the fourth sound outlet hole 16 is toward the helix. Specifically, the included angle between the opening direction of the fourth sound outlet hole 16 toward the antihelix and the above Z axis is 5° to 30°.

Due to the structure of the audio apparatus, the sound outlet holes cannot fully meet the conditions of the quadrupole sound source in the three-dimensional space. In order to optimize the spatial layout and better improve the leakage prevention capability, so that the spatial arrangement of the sound source formed by the sound outlet holes is closer to the structure of the longitudinal quadrupole sound source, the third sound outlet hole 15 and the fourth sound outlet hole 16 may be disposed on the side surface. It may be divided into the following cases:
1. The third sound outlet hole 15 and the fourth sound outlet hole 16 are respectively disposed on the second side surface 1052 and the third side surface 1053;
2. The third sound outlet hole 15 and the fourth sound outlet hole 16 are both disposed on the first side surface 1051;
3. The third sound outlet hole 15 and the fourth sound outlet hole 16 are both disposed on the third side surface 1053 at a position close to the first edge; and
4. The third sound outlet hole 15 is disposed on the second side surface 1052 close to the second edge; the fourth sound outlet hole 16 is disposed on the first side surface 1051, or the fourth sound outlet hole 16 extends from the first side surface 1051 to the third side surface 1053. This case is shown in FIG. 29.

As shown in FIG. 26 and FIG. 29, it is a structural schematic diagram of the first sound outlet hole 13, the second sound outlet hole 14, the third sound outlet hole 15, and the fourth sound outlet hole 16 of the audio apparatus on a human ear auricle. The first sound outlet hole 13 and the second sound outlet hole 14 are disposed on the first surface 103 of the sound emitting portion 17, as illustrated by dotted racetrack-shaped holes in FIG. 29. The long axes of the first sound outlet hole 13 and the second sound outlet hole 14 form an included angle of 0° to 120° with the plane where the short axis of the audio apparatus is located, and the included angle shown in the figure is 90°.

Specifically, the vertical distance between the center of the fourth sound outlet hole 16 and the first edge is less than or equal to 10 mm, and the vertical distance between the center of the third sound outlet hole 15 and the second edge is less than or equal to 10 mm.

Specifically, the center connection line of the first sound outlet hole 13 and the second sound outlet hole 14 forms an included angle between 25° and 70° with the YZ plane; forms an included angle of less than or equal to 150° with the XY plane; and forms an included angle of less than or equal to 150° with the XZ plane.

Specifically, the included angle between the plane perpendicular to the average normal of the first sound outlet hole 13 and the YZ plane is less than or equal to 40°.

Specifically, the included angle between the center connection line of the first sound outlet hole 13 and the second sound outlet hole 14 and the plane formed by the upper ear root, the antihelix, and the tragus notch of the auricle is less than or equal to 35°.

Specifically, the included angle between the plane perpendicular to the average normal of the first sound outlet hole 13 and the plane formed by the upper ear root, the antihelix, and the tragus notch of the auricle is less than or equal to 35°.

Specifically, the center connection line of the third sound outlet hole 15 and the fourth sound outlet hole 16 forms an included angle of less than or equal to 40° with the ZY plane; forms an included angle of less than or equal to 150° with the XY plane; and forms an included angle of less than or equal to 150° with the XZ plane.

Specifically, the included angle between the center connection line of the third sound outlet hole 15 and the fourth sound outlet hole 16 and the YZ plane, and the included angle between the plane perpendicular to the average normal of the third sound outlet hole 15 and the YZ plane are less than or equal to 82°. The included angle between the center connection line of the third sound outlet hole 15 and the fourth sound outlet hole 16 and the plane formed by the upper ear root, the antihelix, and the tragus notch of the auricle is less than or equal to 35°.

Specifically, the included angle between the center connection line of the third sound outlet hole 15 and the fourth sound outlet hole 16 and the plane formed by the notch between the upper ear root, the antihelix, and the tragus of the auricle, and the included angle between the plane perpendicular to the average normal of the first sound outlet hole 13 and the plane formed by the upper ear root, the antihelix, and the tragus notch of the auricle are less than or equal to 65°.

A part of the fourth sound outlet hole 16 is close to the antihelix, and a part of the fourth sound outlet hole 16 is close to the inferior crus of helix, and the distance to the antihelix is 3 mm. In order to reduce the standing wave formed between the fourth sound outlet hole 16 and the antihelix, the ratio of the length of the fourth sound outlet hole 16 to the first surface 103 of the audio apparatus in the height direction is greater than 0.6; or, the ratio of the length of the fourth sound outlet hole 16 to the first surface 103 of the audio apparatus in the length direction is greater than 0.6.

Specifically, the ratio of the length to the width of the sound outlet hole of the second cavity 12 is not less than 2.5.

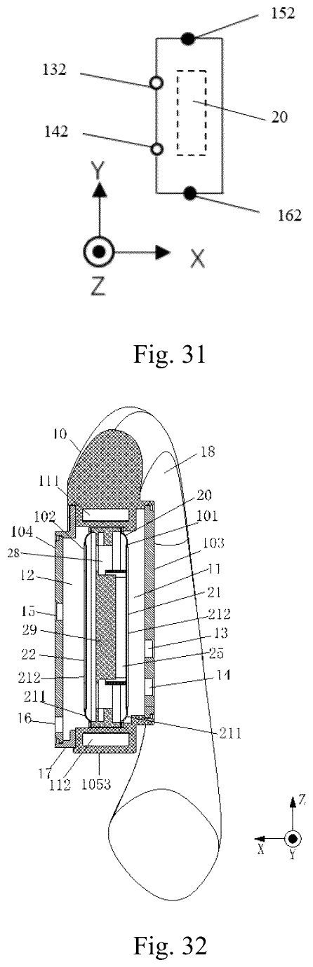

In order to illustrate the relationship between the sound outlet holes, the above-mentioned XYZ coordinate system is used for illustration. The projections of the sound outlet holes on the YZ plane are shown in FIG. 30, and the projections of the sound outlet holes on the XY plane are shown in FIG. 31. The first sound outlet hole 13 is projected on the XY plane to form a fifth projection region 132, the second sound outlet hole 14 is projected on the XY plane to form a sixth projection region 142, the third sound outlet hole 15 is projected on the XY plane to form a seventh projection region 152, and the fourth sound outlet hole 16 is projected on the XY plane to form an eighth projection region 162.

The distance between the projection centers of the first sound outlet hole 13 and the third sound outlet hole 15 on the YZ plane is 4 mm. The distance between the projection centers of the first sound outlet hole 13 and the second sound outlet hole 14 on the YZ plane is 4 mm. The distance between the projection centers of the second sound outlet hole 14 and the fourth sound outlet hole 16 on the plane where the YZ axis is located is 4 mm.

The connection line between the projection centers of the third sound outlet hole 15 and the fourth sound outlet hole 16 on the YZ plane and the connection line of the projections of the first sound outlet hole 13 and the second sound outlet hole 14 on the YZ plane are collinear with each other. The above connection line forms an included angle of less than or equal to 150° with the XY plane. Preferably, the angle is 120° to 150°.

The distance between the projection centers of the first sound outlet hole 13 and the third sound outlet hole 15 on the XY plane is 6 mm, the distance between the projection centers of the second sound outlet hole 14 and the fourth sound outlet hole 16 on the XY plane is 6 mm, and the distance between the projection centers of the first sound outlet hole 13 and the second sound outlet hole 14 on the XY plane is 3 mm.

The center connection line of the first sound outlet hole 13 and the third sound outlet hole 15 passes through the first diaphragm 21 of the speaker unit 20 and forms an included angle of less than or equal to 80° with the plane perpendicular to the vibration direction of the speaker unit 20, and specifically, it is less than or equal to 45°. The included angle between the connection line between the center of the first sound outlet hole 13 and the center of the third sound outlet hole 15 and the reference plane perpendicular to the average normal of the first sound outlet hole 13 is between 15° and 65°.

The center connection line of the second sound outlet hole 14 and the fourth sound outlet hole 16 passes through the first diaphragm 21 of the speaker unit 20 and forms an included angle of less than or equal to 80° with the plane perpendicular to the vibration direction of the speaker unit 20, and specifically, it is less than or equal to 45°. The included angle between the connection line between the center of the second sound outlet hole 14 and the center of the fourth sound outlet hole 16 and the reference plane perpendicular to the average normal of the second sound outlet hole 14 is 15° to 65°.

The fourth sound outlet hole 16 is toward the helix and the inferior crus of helix, specifically toward the antihelix. The included angle between the opening direction and the vertical axis of the user is 5° to 30°.

Based on the above scheme, in the process of optimizing the spatial position of the quadrupole sound source, the position of the sound outlet hole may be adjusted, and the schemes shown in FIG. 26 and FIG. 29 may be obtained. The positions of the first sound outlet hole 13, the second sound outlet hole 14, the third sound outlet hole 15, and the fourth sound outlet hole 16 may be designed according to actual design requirements.

In this case, as described above, one or more speaker units 20 and a passive diaphragm are provided inside the audio apparatus. When the diaphragm of the speaker unit 20 vibrates, sound signals with the same amplitude and opposite phases are emitted in front of and behind the diaphragm.

An embodiment of the present application is shown in FIG. 32, and the speaker unit 20 is provided inside the sound emitting portion 17. The speaker unit 20 includes the first diaphragm 21, the second diaphragm 22, a voice coil 25, and the magnetic circuit assembly 29. With reference to FIG. 29, regarding the position of the sound emitting portion on the auricle, the projection length of the long axis of the speaker unit 20 on the XY plane is greater than or equal to the projection length of the short axis of the speaker unit 20 on the XZ plane.

With reference to FIG. 29, as shown in FIG. 32, the first diaphragm 21 is bonded to the voice coil, and after an alternating current signal is introduced into the voice coil, the voice coil 25 drives the first diaphragm 21 to vibrate under the driving of the magnetic circuit assembly 26. The first diaphragm 21 and the inner wall and the side wall of the first surface 103 of the sound emitting portion 17 form the first cavity 11. The sound signal generated by the first diaphragm 21 emits, through the first sound outlet hole 13 and the second sound outlet hole 14 of the first cavity 11, two sound signals with the same amplitude and the same phase. In this embodiment, the second diaphragm 22 is a passive diaphragm of the speaker unit 20, and the second diaphragm 22 is bonded to the housing 10 of the speaker unit 20 and forms a completely sealed space with the housing 10 of the speaker unit 20 and the first diaphragm 21, and the space becomes the third cavity 28, where components such as the voice coil and the magnetic circuit assembly 26 and the like are arranged in the third cavity 28. During the first vibration, the air in the third cavity 28 is pushed to push the second diaphragm 22 to vibrate in the same direction as the first diaphragm 21. The vibration in the same direction is represented as: when the first diaphragm 21 vibrates in a direction away from the magnetic circuit assembly 26, the second diaphragm 22 vibrates in a direction toward the magnetic circuit assembly 26; on the contrary, when the first diaphragm 21 vibrates in the direction toward the magnetic circuit assembly 26, the second diaphragm 22 vibrates in the direction away from the magnetic circuit assembly 26.

In this embodiment, the second diaphragm 22 is directly bonded and fixed to the speaker unit 20 to form a component. It is easy to think that in this embodiment, the second diaphragm 22 may be separated from the speaker unit 20, so that the second diaphragm 22 is mounted and fixed on the audio apparatus, and the second diaphragm 22, the first diaphragm 21, and the housing of the audio apparatus form the third cavity 28.

Since the first diaphragm 21 needs to further act on the second diaphragm 22 by pushing the air inside the third cavity 28, the smaller the volume of the air sealed in the third cavity 28, the better. Preferably, the volume of the third cavity 28 is less than or equal to 8 cm³.

In order to control the first diaphragm 21 and the second diaphragm 22 to emit sound signals with the same amplitude and opposite phases, it is necessary to control the parameters of the first vibration system where the first diaphragm 20 is located and the vibration system where the second diaphragm 22 is located.

As shown in FIG. 32, the first diaphragm 21 and the first voice coil 25 constitute the first vibration system, and the resonant frequency of the first vibration system is F1. The structure of the second diaphragm 22 is similar to that of the first diaphragm 21, but it does not include a voice coil. Instead, the air in the third cavity 28 is acted on by the first diaphragm 21 to push the second diaphragm 22 to vibrate, so that the second diaphragm 22 constitutes the second vibration system, and the resonant frequency of the second vibration system is F2.

The resonant frequency of the vibration system is affected by the mass, elasticity, and internal damping of the system. The mass of the vibration system is affected by components such as the folded edge 211, the vibrating portion 212, and the first voice coil 25 and the like. The elasticity is affected by the material, thickness, and width of the folded edge 211 and the size of the space sealed by the first diaphragm 21 and the second diaphragm 22. The internal damping is affected by the material of the folded edge 211. The sound radiation capability of the vibration system is affected by the displacement and area of the diaphragm.

When the first diaphragm 21 and the second diaphragm 22 emit sound signals with the same amplitude and opposite phases, the resonant frequency F1 of the first vibration system is close to the resonant frequency F2 of the second vibration system. Preferably, the ratio of F1 to F2 is 0.7 to 1.3.

The folded edge 211 of the second diaphragm 22 has close compliance to the folded edge 211 of the first diaphragm 21. Preferably, the ratio of the folded edge 211 of the second diaphragm 22 to the folded edge 211 of the first diaphragm 21 in terms of thickness is 0.5 to 2.2.

Preferably, the folded edge 211 may be made of materials such as PU and liquid silica gel and the like.

Preferably, the mass of the second vibration system is 0.1 to 2.2 times the mass of the first vibration system.

Preferably, the internal damping of the second diaphragm 22 is 0.5 to 5 times the internal damping of the first diaphragm 21.

Preferably, the area of the second diaphragm 22 is 0.8 to 2 times the area of the first diaphragm 21.

Further, after being coupled by the cavity in front of the diaphragm, the sound signal of the diaphragm emits sound signal through the sound outlet hole. As in this embodiment, the first diaphragm 21 and the inner wall and the side wall of the second surface 103 of the sound emitting portion 17 form the first cavity 11, and the sound signal generated by the first diaphragm 21 is emitted through the first sound outlet hole 13 and the second sound outlet hole 14 of the first cavity 11; the second diaphragm 22 and the inner wall and the side wall of the second surface 104 of the sound emitting portion 17 form the second cavity 12, and the sound signal generated by the second diaphragm 22 is emitted through the third sound outlet hole 15 and the fourth sound outlet hole 16 of the second cavity 12. In order to make the sound outlet holes on the first cavity 11 emit signals with the same amplitude and the same phase, it is necessary to design and adjust the volume of the first cavity, the area of the sound outlet holes, and the openings of the mesh cloth attached to the sound outlet holes. The above design and adjustment are also applicable to the sound outlet holes on the second cavity 12 and the mesh cloth thereof, so that the sound emitted by the sound outlet holes on the first cavity and the sound outlet holes on the second cavity have the same amplitude and opposite phases.

In order to achieve the above effect, the area of each of the first sound outlet hole 13, the second sound outlet hole 14, the third sound outlet hole 15, and the fourth sound outlet hole 16 is not less than 4 mm². When the opening area is relatively small, the radiation capability of the audio apparatus at middle and low frequencies is reduced, and a high-frequency resonance peak is introduced.

Specifically, the area of the first sound outlet hole 13 is 0.4 to 2.5 times the area of the second sound outlet hole 14.

Specifically, the area of the third sound outlet hole 15 is 0.4 to 2.5 times the area of the fourth sound outlet hole 16.

Specifically, the area of the first sound outlet hole 13 is 0.4 to 2.5 times the area of the third sound outlet hole 15.

Specifically, the area of the second sound outlet hole 14 is 0.4 to 2.5 times the area of the fourth sound outlet hole 16.

Specifically, tuning mesh cloth may be attached to the first sound outlet hole 13, the second sound outlet hole 14, the third sound outlet hole 15, and the fourth sound outlet hole 16, and the acoustic resistance formed by the sound outlet holes and the acoustic mesh cloth is less than or equal to 9*109 Pa·s/m³.

Specifically, the volume of each of the first cavity 11 and the second cavity 12 is greater than 0.8 cm³.

Specifically, the volume of the first cavity 11 may be 0.4 to 6 times the volume of the second cavity 12.

Specifically, the distance between the inner surface of the first cavity 11 and the diaphragm (the first diaphragm 21 or the second diaphragm 22) of the speaker unit 20 in the vibration direction of the speaker unit 20 is less than or equal to 3 mm.

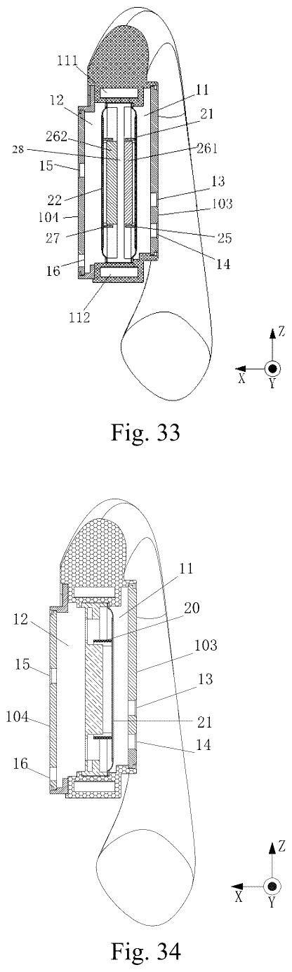

Another embodiment is shown in FIG. 33. In this implementation case, the second vibration system is formed by the second diaphragm 22 and the second voice coil 27. The second diaphragm 22 is sealed and fixed on the housing 10 of the speaker unit 20, and the second voice coil 27 is fixed on one side of the second diaphragm 22. The first vibration system is formed by the first diaphragm 21 and the first voice coil 25. When the speaker unit 20 is in operation, the first voice coil 25 and the second voice coil 27 are connected in series. When the same audio signal flows through the first voice coil 25 and the second voice coil 27, the first vibration system and the second vibration system vibrate in the same direction. The first diaphragm 21 and the second diaphragm 22 and the housing 10 of the speaker unit 20 form the third cavity 28, and components such as the magnetic circuit assembly 26, the first voice coil 25, and the second voice coil 27 and the like of the speaker unit 20 are sealed in the third cavity 28, and the space is less than or equal to 8 cm³. There are two magnetic circuit assemblies 26, which are a first magnetic circuit 261 and a second magnetic circuit 262, respectively. Preferably, the space is less than or equal to 2 cm³. As in the previous embodiment, in this embodiment, the first vibration system includes the first diaphragm 21 and the first voice coil 25, and the second vibration system includes the second diaphragm 22 and the second voice coil 27. In order to make the first diaphragm 21 and the sound outlet holes of the first cavity 11 and the second diaphragm 22 and the sound outlet holes of the second cavity 12 emit sounds with the same amplitude and opposite phases, the related parameters of the first vibration system and the second vibration system, the sound outlet holes, the mesh cloth, and the like are the same as those in the previous embodiment, and are not repeated herein.

In another embodiment, as shown in FIG. 34, the speaker unit 20 in the previous embodiment is replaced with a speaker unit 20 having only one diaphragm. In this embodiment, the front side of the speaker unit 20 is opposite to the first cavity 11, and the rear end of the speaker unit 20 is opposite to the second cavity 12. The spatial relationships such as the size of the sound outlet holes and the size of the sound outlet holes and the diaphragm and the like in the previous embodiment may also form a quadrupole sound source for the audio apparatus in this embodiment, and the technology is also applicable.

Another embodiment is shown in FIG. 35. In the audio apparatus shown in FIG. 33, the first voice coil 25 of the speaker unit 20 is fixedly connected to both the first diaphragm 21 and the second diaphragm 22. The first diaphragm 21 and the first voice coil 25 constitute the first vibration system, and the resonant frequency of the first vibration system is F1. The structure of the second diaphragm 22 is similar to that of the first diaphragm 21, and the second diaphragm 22 and the first voice coil 25 constitute the second vibration system, and the resonant frequency of the second vibration system is F2. The first diaphragm, the second diaphragm, and the housing of the speaker 20 form a sealed space. When the first voice coil 25 has a current signal, the first voice coil 25 pushes the first diaphragm and the second diaphragm to move in the same direction. In order to make the first diaphragm and the sound outlet holes of the first cavity and the second diaphragm and the sound outlet holes of the second cavity emit sounds with the same amplitude and opposite phases, the related parameters of the first vibration system and the second vibration system, the sound outlet holes, the mesh cloth, and the like are the same as those in the embodiment shown in FIG. 32, and are not repeated herein.

As shown in FIGS. 14-17, one or more acoustic dipole tubes may be arranged between the first cavity 11 and the second cavity 12, and in this embodiment, a first dipole tube 111 and a second dipole tube 112 are included. The first dipole tube 111 and the second dipole tube 112 are used for communicating the first cavity 11 with the second cavity 12. The open end faces of the first dipole tube 111 and the second dipole tube 112 are respectively located in the first cavity 11 and the second cavity 12, and the parameters of the first dipole tube 111 and the second dipole tube 112 are adjusted to improve the capability of preventing sound leakage.

In another embodiment, the speaker unit 20 is replaced with two speaker units 20 each having only one diaphragm, as shown in FIG. 35. The speaker unit 20 includes the first speaker 201 and the second speaker 202. The first speaker 201 and the second speaker 202 are mounted back to back, the diaphragm of the first speaker 201 is disposed opposite to the first cavity 11, and the diaphragm of the second speaker 202 is disposed opposite to the second cavity 12.

The diaphragm 21 of the first speaker 201, the diaphragm 23 of the second speaker 202, and the housing form the third cavity 28. The magnetic circuit system of the speaker unit 20 is located in the sealed cavity, and can be well protected from the erosion of external liquid, thus maintaining the performance of the speaker unit.

The volume of the sealed space is less than or equal to 8 cm³, and preferably, less than or equal to 3 cm³.

The first vibration system is provided by the first diaphragm 21 and the voice coil attached thereto, and the second vibration system is provided by the second diaphragm 22 and the voice coil attached thereto. In order to make the first diaphragm and the sound outlet holes of the first cavity and the second diaphragm and the sound outlet holes of the second cavity emit sounds with the same amplitude and opposite phases, the related parameters of the first vibration system and the second vibration system, the sound outlet holes, the mesh cloth, and the like are the same as those in the embodiment shown in FIG. 32, and are not repeated herein.

In another embodiment, as shown in FIG. 18, the speaker unit 20 includes a first speaker 201, a second speaker 202, a third speaker 203, and a fourth speaker 204, where each speaker includes a diaphragm. The diaphragms corresponding to the first speaker 201, the second speaker 202, the third speaker 203, and the fourth speaker 204 are a first diaphragm 21, a second diaphragm 22, a third diaphragm 23, and a fourth diaphragm 24, respectively.

Spatially, the first diaphragm 21, the second diaphragm 22, the third diaphragm 23, and the fourth diaphragm 24 may be back to back, or back to back side by side, or side by side on the same side.

The sound emitted by each sound outlet hole may be provided by an independent diaphragm radiating a sound signal outward. The first diaphragm 21 emits sound to the outside through the first sound outlet hole 13 coupled through the first cavity 11; the second diaphragm 22 is coupled through the second cavity 12 and emits a sound signal to the outside through the third sound outlet hole 15; the third diaphragm 23 is coupled through the seventh cavity 30 and emits a sound signal to the outside through the second sound outlet hole 14; and the fourth diaphragm 24 is coupled through the fourth cavity 29 and emits a sound signal to the outside through the fourth sound outlet hole 16.

The first diaphragm 21 and the second diaphragm 22 and the outer wall of the speaker unit 20 or the inner wall of the housing 10 form a sealed space, which is referred to as a fifth cavity 281. The magnetic circuit assemblies, the voice coils, etc. of the first speaker 201 and the second speaker 202 are sealed in the fifth cavity 281. The diaphragms of the first diaphragm 21 and the second diaphragm 22 may be driven in pairs, have the same vibration direction, and may emit sounds with the same amplitude and opposite phases.

The third diaphragm 23, the fourth diaphragm 24, and the outer wall of the third speaker 203, the fourth speaker 204, or the inner wall of the housing 10 form a sealed space, which is referred to as a sixth cavity 291. The magnetic circuit assemblies, the voice coils, etc. of the third speaker 203 and the fourth speaker 204 are sealed in the sealed space. The diaphragms of the third diaphragm 23 and the fourth diaphragm 24 may be driven in pairs, have the same vibration direction, and may emit sounds with the same amplitude and opposite phases.

The first diaphragm 21 and the third diaphragm 23 emit sounds with the same amplitude and the same phase; similarly, the second diaphragm 22 and the fourth diaphragm 24 emit sounds with the same amplitude and the same phase. The sound emitted by the diaphragm is radiated outward through the four cavities and the sound outlet holes. The sound outlet hole 13 of the first cavity 11 and the sound outlet hole 15 of the second cavity 12 are analogous to the first sound outlet hole 13 and the third sound outlet hole 15 mentioned above, and the emitted sound constitutes a pair of dipole-like sound sources. The sound outlet hole 14 of the third cavity 30 and the sound outlet hole 16 of the fourth cavity 29 are analogous to the second sound outlet hole 14 and the fourth sound outlet hole 16 mentioned above, and the emitted sound constitutes a pair of dipole-like sound sources, and the two pairs of dipole-like sound sources constitute a quadrupole-like sound source. The parameters such as the size of the sound outlet hole, the position of the sound outlet hole, and the angle of the sound outlet hole and the like mentioned above are also applicable in this case.

In FIG. 17, the first diaphragm 21 and the second diaphragm 22 form the first cavity 11 and the second cavity 12 with the housing 10 through the speaker bracket, and the first diaphragm 21 and the second diaphragm 22 form the sealed fifth cavity 281 with the housing 10 through the speaker bracket;

The back side of the first diaphragm 21, that is, the side close to the magnet, is communicated with the fifth cavity 281 through the sound outlet hole on the speaker bracket; the back side of the second diaphragm 22, that is, the side close to the magnet, is communicated with the fifth cavity 281 through the sound outlet hole on the speaker bracket; and the first diaphragm 21 and the second diaphragm 22 may be driven in pairs to emit sounds with the same amplitude and opposite phases;

The third diaphragm 23 and the fourth diaphragm 24 form the seventh cavity 30 and the fourth cavity 29 with the housing 10 through the speaker bracket, and the third diaphragm 23 and the fourth diaphragm 24 form the sealed sixth cavity 291 with the housing 10 through the speaker bracket;

The back side of the third diaphragm 23, that is, the side close to the magnet, is communicated with the sixth cavity 291 through the sound outlet hole on the speaker bracket; the back side of the fourth diaphragm 24, that is, the side close to the magnet, is communicated with the sixth cavity 291 through the sound outlet hole on the speaker bracket; and the third diaphragm 23 and the fourth diaphragm 24 may be driven in pairs to emit sounds with the same amplitude and opposite phases;

As mentioned above, the volume of the fifth cavity 281 and the volume of the sixth cavity 291 cannot be too large, and in some implementations, they are less than or equal to 8 cm³, and more preferably, less than or equal to 3 cm³.

In order to achieve a good acoustic quadrupole effect, the vibration systems of the first speaker 201, the second speaker 202, the third speaker 203, and the fourth speaker 204 are close to each other in resonant frequency.

The speaker unit 20 or the passive diaphragm provides the vibration system, the first vibration system is provided by the first speaker unit 201, the second vibration system is provided by the second speaker unit 202, the third vibration system is provided by the third speaker unit 203, and the fourth vibration system is provided by the fourth speaker unit 204.

The first vibration system and the second vibration system have close resonant frequencies, and specifically, the ratio of the resonant frequencies is 0.7 to 1.3.

The third vibration system and the fourth vibration system have close resonant frequencies, and specifically, the ratio of the resonant frequencies is 0.7 to 1.3.

The second vibration system and the fourth vibration system have close resonant frequencies, and specifically, the ratio of the resonant frequencies is 0.7 to 1.3.

The folded edge 211 of the third diaphragm 23 has close compliance to the folded edge 211 of the first diaphragm 21. Specifically, the ratio of the folded edge 211 of the third diaphragm 23 to the folded edge 211 of the first diaphragm 21 in terms of thickness is 0.88 to 2.2.

Specifically, the folded edge 211 is made of materials such as PU and liquid silica gel and the like.

Preferably, the mass of the fourth vibration system is 0.1 to 2.2 times the mass of the second vibration system.

Preferably, the internal damping of the fourth diaphragm 24 is 0.5 to 5 times the internal damping of the second diaphragm 22.

Preferably, the area of the fourth diaphragm 24 is 0.8 to 2 times the area of the second diaphragm 22.

The folded edge 211 of the second diaphragm 22 has close compliance to the folded edge 211 of the first diaphragm 21, and preferably, the ratio of the folded edge 211 of the second diaphragm 22 to the the folded edge 211 of the first diaphragm 21 in terms of thickness is 0.9 to 1.1.

Specifically, the folded edge 211 is made of materials such as PU and liquid silica gel and the like.

Specifically, the mass of the second vibration system is 1.05 to 1.2 times the mass of the first vibration system.

Specifically, the internal damping of the third diaphragm 23 is 0.9 to 1.1 times the internal damping of the first diaphragm 21.

Specifically, the area of the second diaphragm 22 is close to the area of the first diaphragm 21.

In this embodiment, the parameters of the first cavity 11 and the sound outlet hole 13 thereof, the seventh cavity 30 and the sound outlet hole 14 thereof, the second cavity 12 and the sound outlet hole 15 thereof, and the fourth cavity 24 and the sound outlet hole 16 thereof are the same as those in the embodiment shown in FIG. 32, and are not repeated herein.

In some embodiments, referring to the embodiment in FIG. 18, it may be easily conceived to replace the second speaker 203 and the fourth speaker 204 with passive diaphragms, and the passive diaphragms may be fixed on the housing of the audio apparatus by gluing and sealing, and the effect in the embodiment in FIG. 17 may be achieved by adjusting the mass, compliance, and internal damping of the passive diaphragms.

Another embodiment is shown in FIG. 19. Referring to the embodiment shown in FIG. 19, two speakers may be replaced with a single speaker with dual magnetic circuits and dual diaphragms through design. Specifically, the speaker unit 20 includes two speakers having two diaphragms. The speaker unit 20 includes a first speaker 201 and a second speaker 202, where the first speaker 201 has a first diaphragm 21 and a second diaphragm 22, and the second speaker 202 has a third diaphragm 23 and a fourth diaphragm 24. The first diaphragm 21 and the second diaphragm 22 and a bracket of the first speaker 201 form a sealed cavity 281, the magnetic circuit system is located in the sealed space, the third diaphragm 223 and the fourth diaphragm 24 and the second speaker 202 form a sealed space 291, and the magnetic circuit system is located in the sealed space.

The volume of the sealed space is less than or equal to 8 cm³, and preferably, less than or equal to 3 cm³.

The first vibration system is provided by the first diaphragm 21 and the voice coil attached thereto, the second vibration system is provided by the second diaphragm 22 and the voice coil attached thereto, the third vibration system is provided by the third diaphragm 23 and the voice coil attached thereto, and the fourth vibration system is provided by the fourth diaphragm 24 and the voice coil attached thereto. The related vibration system technology is similar to that in the embodiment shown in FIG. 18, and is not described in detail here.

In this embodiment, the related parameters of the first cavity 11 and the sound outlet hole 13 thereof, the second cavity 12 and the sound outlet hole 15 thereof, the seventh cavity 30 and the sound outlet hole 14 thereof, the fourth cavity 24 and the sound outlet hole 16 thereof, the fifth cavity 281, and the sixth cavity 291 are the same as those in the embodiment shown in FIG. 32, and are not repeated herein. Through the implementation of the acoustic quadrupole in the above solution, compared with the acoustic dipole, it has achieved better improvement in both the acoustic far-field sound leakage and the near-field listening.

As shown in FIG. 20, the solid line is the frequency response curve of the quadrupole sound source solution, and the dotted line is the frequency response curve of the dipole sound source solution. Comparing the two curves, the solid line has a higher sound pressure level at 170 Hz to 2000 Hz, and the middle and low frequencies perform better; at 5900 Hz to 20000 Hz, the solid line has a higher sound pressure level. Therefore, it may be seen that compared with the dipole sound source solution, the quadrupole sound source solution has a better sound reproduction capability in the middle and high frequency bands, and is more capable of representing the detail and richness of the sound, and the sound quality is better.

As shown in FIG. 21, which is a comparison of sound leakage curves, the higher the sound pressure level of the frequency response curve, the more the leaked sound. The solid line is the curve of the sound leakage prevention capability of the quadrupole sound source solution, and the dotted line is the curve of the sound leakage prevention capability of the dipole sound source solution. Obviously, in the frequency band of 300 Hz to 6000 Hz that is sensitive to human ears, the quadrupole sound source solution has a better capability of preventing sound leakage.

Compared with the prior art, in the present application, the first cavity 11 and the second cavity 12 are provided by the front end and the rear end of the speaker unit 20, and the first cavity 11 is provided with the first sound outlet hole 13 and the second sound outlet hole 14, and the second cavity 12 is provided with the third sound outlet hole 15 and the fourth sound outlet hole 16. The sound emitted from the first sound outlet hole 13 and the second sound outlet hole 14 has the same amplitude and opposite phase as the sound emitted from the third sound outlet hole 15 and the fourth sound outlet hole 16, thereby forming a multipole sound source. The multipole sound source has a better attenuation for the middle and low frequency bands, especially the middle frequency band that is sensitive to human ears. When the multipole sound source is used in a non-invasive audio apparatus, sound leakage may be effectively prevented and user privacy may be improved.

Obviously, those skilled in the art may make various modifications and variations to the present application without departing from the spirit and scope of the present application. In this way, if these modifications and variations of the present application fall within the scope of the claims of the present application and their equivalent technologies, the present application is also intended to include these modifications and variations.

1. An audio apparatus, wherein the audio apparatus comprises a sound emitting portion, the sound emitting portion comprises a housing and at least one speaker unit, the speaker unit comprises at least one diaphragm, the speaker unit is disposed inside the housing, a first cavity is formed by enclosing between a front end wall of the diaphragm and an inner peripheral wall of a front end portion of the housing, a second cavity is formed by enclosing between a rear end wall of the diaphragm and an inner peripheral wall of a rear end portion of the housing, the first cavity is provided with a first sound outlet hole and a second sound outlet hole, the second cavity is provided with a third sound outlet hole and a fourth sound outlet hole, the first sound outlet hole, the second sound outlet hole, the third sound outlet hole, and the fourth sound outlet hole are respectively projected on a plane perpendicular to a vibration direction of the diaphragm to form a first projection region, a second projection region, a third projection region, and a fourth projection region, a range of a distance of a connection line between center points of any two of the first projection region, the second projection region, the third projection region, and the fourth projection region is 0 mm to 25 mm, and the first projection region and the second projection region are respectively located on two sides of a straight line where a connection line between a center point of the third projection region and a center point of the fourth projection region is located.

2. An audio apparatus, wherein the audio apparatus comprises a sound emitting portion, the sound emitting portion comprises a housing and at least one speaker unit, the speaker unit comprises at least one diaphragm, the speaker unit is disposed inside the housing, a first cavity is formed by enclosing between a front end wall of the diaphragm and an inner peripheral wall of a front end portion of the housing, a second cavity is formed by enclosing between a rear end wall of the diaphragm and an inner peripheral wall of a rear end portion of the housing, the first cavity is provided with a first sound outlet hole and a second sound outlet hole, the second cavity is provided with a third sound outlet hole and a fourth sound outlet hole, the first sound outlet hole, the second sound outlet hole, the third sound outlet hole, and the fourth sound outlet hole are respectively projected on a plane perpendicular to a vibration direction of the diaphragm to form a first projection region, a second projection region, a third projection region, and a fourth projection region, a range of a distance of a connection line between center points of any two of the first projection region, the second projection region, the third projection region, and the fourth projection region is 0 mm to 25 mm, and the first projection region and the second projection region are located on a straight line where a connection line between a center point of the third projection region and a center point of the fourth projection region is located, or on a same side of the straight line where the connection line between the center point of the third projection region and the center point of the fourth projection region is located.

3. (canceled)

4. The audio apparatus of claim 1, wherein a distance between the center point of the third projection region and the center point of the fourth projection region is not less than a distance of a connection line between a center point of the first projection region and a center point of the second projection region.

5. (canceled)

6. The audio apparatus of claim 1, wherein the speaker unit is provided with one diaphragm, the first cavity is disposed at a front end portion of the diaphragm, and the second cavity is disposed at a rear end portion of the diaphragm.

7. The audio apparatus of claim 1, wherein the speaker unit is provided with two diaphragms, which are respectively set as a first diaphragm and a second diaphragm, the first diaphragm is disposed in the first cavity, and the second diaphragm is disposed in the second cavity.

8-11. (canceled)

12. The audio apparatus of claim 1, wherein a first assembly surface and a second assembly surface are provided inside the housing, the speaker unit is disposed between the first assembly surface and the second assembly surface, the first diaphragm is located on the first assembly surface, and the second diaphragm is located on the second assembly surface.

13. The audio apparatus of claim 1, wherein an outer surface of the housing comprises a first surface, a second surface, and a side surface, the first surface is an outer side surface of the first cavity, and the second surface is an outer side surface of the second cavity.

14. The audio apparatus of claim 13, wherein the side surface comprises a first side surface, a second side surface, and a third side surface, the third side surface is a side surface connecting the first surface and the second surface at a bottom of the housing, the first side surface and the second side surface are side surfaces respectively disposed on two sides of the third side surface, and the first side surface and the second side surface are connected to side edges of the first surface and the second surface.

15. The audio apparatus of claim 13, wherein the first sound outlet hole and the second sound outlet hole are simultaneously disposed on the first surface, or simultaneously disposed on the side surface, or respectively disposed on the first surface and the side surface, or simultaneously disposed on the second surface, or respectively disposed on the second surface and the side surface.

16. The audio apparatus of claim 13, wherein the third sound outlet hole and the fourth sound outlet hole are simultaneously disposed on the second surface, or simultaneously disposed on the side surface, or respectively disposed on the second surface and the side surface, or simultaneously disposed on the first surface, or respectively disposed on the first surface or the side surface.

17. The audio apparatus of claim 13, wherein the first surface is provided with a convex structure, and the first sound outlet hole and the second sound outlet hole are both disposed on an end surface of the convex structure.

18-19. (canceled)

20. The audio apparatus of claim 1, wherein the audio apparatus further comprises a hook-shaped band, the hook-shaped band is used to wear the audio apparatus on a human ear, the first cavity and the second cavity are both disposed in the sound emitting portion, the first sound outlet hole, the second sound outlet hole, the third sound outlet hole, and the fourth sound outlet hole are all disposed on an outer side wall of the sound emitting portion.

21-30. (canceled)

31. The audio apparatus of claim 1, wherein a center connection line of the first sound outlet hole and the third sound outlet hole passes through the diaphragm of the speaker unit, and an included angle between the center connection line of the first sound outlet hole and the third sound outlet hole and a plane perpendicular to the vibration direction of the speaker unit is less than or equal to 80°.

32. The audio apparatus of claim 1, wherein a range of an included angle between a center connection line of the first sound outlet hole and the third sound outlet hole and a plane perpendicular to an average normal of the first sound outlet hole is 15° to 75°.

33. The audio apparatus of claim 1, wherein a center connection line of the second sound outlet hole and the fourth sound outlet hole passes through the diaphragm of the speaker unit, and an included angle between the center connection line of the second sound outlet hole and the fourth sound outlet hole and a plane perpendicular to the vibration direction of the speaker unit is less than or equal to 80°.

34. The audio apparatus of claim 1, wherein a range of an included angle between a center connection line of the second sound outlet hole and the fourth sound outlet hole and a plane perpendicular to an average normal of the second sound outlet hole is 15° to 75°.

35-47. (canceled)

48. The audio apparatus of claim 1, wherein
a range of an included angle between a connection line between a center point of the first projection region and a center point of the second projection region and a connection line between the center point of the third projection region and the center point of the fourth projection region is 60° to 90°.

49. The audio apparatus of claim 1, wherein connection lines between center points of projections of the first sound outlet hole, the second sound outlet hole, the third sound outlet hole, and the fourth sound outlet hole on a plane perpendicular to the vibration direction of the diaphragm enclose to form a quadrilateral.

50. The audio apparatus of claim 6, wherein a quadrilateral is a parallelogram; and/or,
interior angles of the quadrilateral are all greater than 28°.

51. The audio apparatus of claim 2, wherein a range of a difference between a distance between a center point of the first projection region and the center point of the third projection region and a distance between a center point of the second projection region and the center point of the third projection region is 0 mm to 5 mm.

52. The audio apparatus of claim 2, wherein a difference between a vertical distance from a center point of the first projection region to a center point connection line between the third projection region and the fourth projection region and a vertical distance from a center point of the second projection region to a center point connection line between the third projection region and the fourth projection region is less than 10 mm.

53. The audio apparatus of claim 2, wherein a distance between a center point of the first sound outlet hole and a center point of the third sound outlet hole is less than or equal to 20 mm.
